(19) United States
(12) Patent Application Publication
(10) Pub. No.: US 2018/0258621 A1
(43) Pub. Date: Sep. 13, 2018

(54) FLUID MIXER TAP OR VALVE

(71) Applicant: BINAY KUMAR BINAY KUMAR, VADODARA (IN)

(72) Inventor: BINAY KUMAR BINAY KUMAR, VADODARA (IN)

(73) Assignee: Binay Kumar Binay Kumar, Vadodara (IN)

(21) Appl. No.: 15/563,623

(22) PCT Filed: May 10, 2016
(86) PCT No.: PCT/IN2016/000122

§ 371 Date: Oct. 5, 2017

(30) Foreign Application Priority Data
May 20, 2015 (IN) 1980/MUM/2015

(51) Int. Cl. E03C 1/02; E03C 1/04; F16K 11/20; F16K 11/00

(52) U.S. Cl. CPC E03C 1/023; E03C 1/0403; F16K 19/006; F16K 11/207; F16K 11/205

(57) ABSTRACT

The invention relates to a water mixer tap, for mixing hot/cold fluid or water, having one tap body-cartridge-handle with plurality of concentric legs or tails connected to concentric ports in the cartridge/plurality of tap bodies-cartridges-handles with plurality of concentric or parallel legs or tails connected to individual tap bodies such that discharge of fluid or water from all tap bodies finally entered into a common header for all tap bodies for discharge of fluid in a mixer chamber in various embodiments of the present invention Fluid Mixer Tap. The tap handle rotatably mounted about a longitudinal axis with respect to the tap body and operatively connected to the tap cartridge or valve assembly such that rotating the handle to a selected position connects inner and outer port/concentric inner and outer ports to a mixing chamber in header and controls the proportions of the hot and cold water supplied from the mixing chamber from the respective hot and cold water supply lines for discharge through the spout In one preferred embodiment there is interlocking of hot and cold water line, such that hot water can entered into spout only when cold water valve is open other wise hot water will not enter the spout. In some embodiments invented tap fittings Toupling C or Taptee T are used for connecting to hot/cold inlet water supply lines where as in some other embodiment they are not used. Here the inlet legs are directly connected to pipe fittings and hose connectors. The taps are attachable to kitchen sink, bathtub or washbasin or baths in various embodiments as per design. Moreover, the inventive mixer tap can be used as a mixer tap or valve for mixing two or more type of fluids in a single unit. The use of the invention makes it possible to improve life cycle and ease of installation along with robust construction and economical cost of water mixer tap for consumer.

There are twelve embodiments and further embodiments are disclosed in the present invention Fluid Mixer Taps or Valves (FMT) which are developed for use in baths, kitchen sinks, wash area, bath tubs, industries, hospitals etc. according to respective embodiments and attachable to them for delivery of mixed water/fluids. The Fluid Mixer Taps (Valves) comprises, in the First to Eighth embodiments of the present invention, two main parts in each embodiment one is a main body and the other is either a Toupling C or a Taptee T connected to the main body as per various drawings in FIG. 1 to FIG. 11 and in the ninth to twelfth embodiments neither Toupling C nor Taptee T is required to be attached to the main body wherein there is only one body which are thought of and developed to provide mixing facility in a single body for connection to elbows or tees or any other suitable pipe fittings for cold and hot water or/and raw water separately in cases where there are two/three tap bodies and two/three input legs or tails respectively. There are plurality of legs or tails for connection to the hot water supply line and cold water supply line.

### 2. FIELD AND BACKGROUND OF THE INVENTION

The present invention Fluid Mixer Tap or Valve (FMT) relates to a water/fluid mixer tap or valve that mixes water/fluid from two or more inlet water/fluid supply lines and discharge mixed water/fluid from its outlet.

Here hot and cold water/fluids or any other two or more types of fluids from two or more inlet supply lines respectively are mixed by this Fluid Mixer Tap or Valve before reaching the outlet, allowing in the case of hot and cold water supply lines to emerge water at any temperature between that of hot and cold water inlet supplies and in case of two or more type of inlet fluids, a mixer of fluids depending upon opening of individual handle for single handle disc cartridges or opening position of a number of tap handles in case of more number of tap handles in the present invention FMT.

In prior arts, various types of water mixer taps are available. In one type water mixer tap uses two taps one for hot water and other for cold water separately and their outlet are common from where one outlet pipe or spout is connected through which mixed water discharges. In other case two separate taps are connected separately to hot and cold water supply lines and discharging individually hot and cold water in washbasin or bath tub or in kitchen sink where mixing of water takes place. In ceramic disc cartridges water mixer taps are single handle mixer taps. They work using two ceramic disks which have holes that, when aligned, allow the water to pass. This means that disk taps only ever require a quarter turn to reach full capacity and are easily handled.

Indoor taps commonly found in bathroom or kitchen or wash area are a single-handle, double-spout tap (one spout for hot water and other for cold water) or double-handle, single-spout tap or mono block disc cartridges tap having two parallel steel armoured hose connector pipes one for cold water and other for hot water screwed in tap body.

Body of single lever tap or double-handle, single-spout tap or mono block disc cartridges tap are fitted to a washbasin or a kitchen sink or bathtubs etc. by means of horse shoes rubber washer and horse shoes metal washer with the help of bolt screwed to body of the tap. Also there are two separate water hose connector in parallel one for hot water and other for cold water screwed in the tap body at one end. Allen key spanner is required for tightening and opening of this bolt which is not a standard plumbing tools. Also both water hose connectors are having one end threaded metallic male nipple and other end threaded metallic female socket. Installation of these taps are difficult and needs additional non plumbing tool in addition to horse shoes washers and bolt. Also these hose connectors can not be used properly in non metallic taps. These mixer taps do not have interlocking mechanism between hot and cold water in which hot water will come out only when cold water valve is in open condition.

A tap, also called spigot or faucet in some regions in the world, is a valve controlling release of liquids or gas, broadly categories as 1. Water taps, 2. Beer taps, 3. Gas taps, 4. Various types of valves.

Water for baths, sinks and basins can be provided by separate hot and cold taps; this arrangement is common in older installations, particularly in public washrooms/lavatories and utility rooms/laundries. This is a costly affairs as cost of two taps may be higher and also there is a risk of scolding injuries due to hot water if water temperature is high.

In kitchens and bathrooms mixer taps are commonly used in many countries. In mixer taps, hot and cold water from two valves is mixed before reaching the outlet, allowing the water to emerge at any temperature between that of the hot and cold water supplies as separately opening of two valves.

For baths and showers, mixer taps frequently incorporate some sort of pressure balancing feature so that the hot/cold mixture ratio will not be affected by transient changes in the pressure of one or the other of the supplies. Especially for baths and showers, to do this using a built-in thermostat. These are known as thermostatic mixing valves.

If separate taps are used for hot and cold water, it may not be immediately clear which tap is hot and which is cold. The hot tap generally has a red indicator while the cold tap generally has a blue or green indicator. Mixer taps may have a red-blue stripe or arrows indicating which side will give hot and which cold. Hot is on the left in many countries by default. In most countries, there is a standard arrangement of hot/cold taps. Mis-assembly of some single-valve mixer taps will exchange hot and cold even if the fixture has been plumbed correctly.

Most water, gas and fluid taps and valves have adjustable flow. Turning the knob or working the lever sets the flow rate by adjusting the size of an opening in the valve assembly, giving rise to choked flow through the narrow opening in the valve.

Globe valves uses a soft rubber or neoprene washer which is screwed down onto a valve seat in order to stop the flow.

Gate valves use a metal disc the same diameter as the pipe which is screwed into place perpendicularly to the flow, cutting it off There is no resistance to flow when the tap is fully open as it is there in globe valve, but this type of tap rarely gives a perfect seal when closed.

Cone valves or ball valves commonly used as the service shut-off valves in more-expensive water systems and usually found in gas taps.

Hands free infrared proximity sensors used in thermostatically controlled electronic dual-purpose mixing or diverting valves are used within industrial applications to automatically provide liquids as required.

Modern bathroom and kitchen taps often use ceramic or plastic surfaces sliding against other spring-loaded ceramic surfaces or plastic washers used in many countries. These tend to require far less maintenance than traditional globe valves and when maintenance is required, the entire interior of the valve is usually replaced, often as a single pre-assembled cartridge.

In many countries bibcocks to have a vacuum breaker or backflow preventer, so that water cannot return through the bibcock from the hose. This prevents contamination of the building or public water system should there be a pressure drop. Some times a double check valve often incorporated within the body of the tap itself is required to conform with water regulations.

Various types of water mixer taps and fluid mixer valves are
1. Ceramic disc cartridge taps,
2. Non rising spindle tap,
3. Rising spindle tap,
4. Single handle mixer tap,
5. Mono block mixer tap,
6. Kitchen mixer tap.
7. Shower mixer tap,
8. Thermostatic mixer tap,
9. Twin lever mixer tap,
10. Wall mounted mixer taps,
11. Lever wall mounted kitchen tap,
12. Wall mounted kitchen tap,
13. Single handle mixer valve,
14. Thermostatic Mixing valves (TMVs).

Various types of tap cartridges available are Ceramic disc cartridge, side fixing ceramic disc cartridge, two inlet ceramic disc cartridge, two inlet joystick operated ceramic disc cartridges, open outlet ceramic disc cartridge, joy stick operated ceramic cartridges, value tap cartridges, mono block ceramic mixer cartridge, sedal cartridge, rising spindle cartridge, non rising spindle cartridge etc.

Various types of mixer valves available are single handle mixer valve, thermostatic mixing valves, Freuer faucets temperature mixing valve for touchless sensor faucet polished chrome, water temperature mixing valve, Dynafluid steam and water mixing valve etc.

The existing single lever-disc cartridges mixer tap, double lever-single spout or any other similar water mixer tap available are having tap body in upper part and have no legs or tails as part of the tap body. This make them susceptible to more damage and require more maintenance. Its cumbersome and difficult arrangement for fixing them in the sink, washbasin, bathtubs etc. make it difficult to maintain in addition to high cost.

The disadvantages with exiting mixer taps are tap body has no legs or tails as its integral part, its high cost, difficult installation using two nuts and bolts, metal horseshoes, rubber horseshoes and a box spanner for tightening two nuts and bolts, steal armoured hose pipe connectors for hot and cold water pull out taps, metal female couplers in the bottom of the tap body for connecting two hose pipe connector (pull out taps), scalding leading to some time serious injuries, thermal shock, siphoning of hot water in cold water line either due to low pressure of cold water line or the cold municipality water unavailability, clean and sediment free municipality water requirement etc. The other problem is two hose pipe connectors are parallel and connected to bottom of the pull out tap allowing less water flow rate in addition to high cost. Also removing nuts for dismantling or removing the tap body for maintenance is very difficult because of handle of box spanner and location washbasin or kitchen sink etc. The box spanner and its handle are not a standard plumbing tools. Scalding and thermal shocks to kids is also a major issue related to kids. These taps have separate tap body fitted on top of kitchen sink or washbasin or bath tub using various items like nuts-bolts, horse shoes and a special box spanner for tightening the nuts-bolts. Inside the tap body cartridge is fixed and also spout is fixed outside the tap body or inbuilt spout is available in the tap body. If nuts-bolts are not tighten properly or over the period it gets loosen than the top body will get dislocated and operating it will be uncomfortable. Also there is no interlocking mechanism between cold and hot water in delivery line such that hot water will be discharged only after the cold water has been discharged or vice versa as per inlet supply line connection.

None of the above mixer taps or valves of prior arts have interlocking of hot water with respect to cold water in discharge line of a tap or valve there by protecting user from scalding injuries and thermal shocks and also non of them have concentric plurality of legs or tails or plurality of legs or tails as part of single tap body for their cost effective and ease of fittings to surface of kitchen sinks, washbasins, bathtubs etc. or their ease of connection in water lines of shower, other pipe fittings etc. and non have innovative tap fittings like Toupling C and Taptee T.

Various embodiments of the present invention Fluid Mixer Taps or Valves (FMT) are conceived and developed to use it for household as well as in industries as an efficient, reliable, robust, easy to maintain, easy to fit and dismantled and economical substitute for the existing water mixer taps with ease of use, installation and maintenance along with interlocking mechanism for hot water delivery with respect to cold water delivery described in various embodiments of the present invention. The manufacturing of this Fluid Mixer Tap or Valve (FMT) is also easy.

### 3. SUMMARY OF THE INVENTION

There are twelve embodiments and further embodiments disclosed in the present invention Fluid Mixer Tap or Valve (FMT) which are developed for use in baths, kitchen sinks, wash area, bath tubs, industries, hospitals etc. according to respective embodiments and attachable to them for delivery of mixed water/fluids.

Various embodiments of the present invention Fluid Mixer Tap or Valve (FMT) are thought of and developed and described to meet the requirement of having a tap (valve) with a tap body/bodies and a plurality of legs or tails as its/their integral parts to be used for easy fittings to support surface and easy connection to input water/fluid supply lines, interlocking mechanism for hot and cold water supply lines in such a way that discharge of water from the tap can only happen when the cold water tap is open and water is coming out from it as described in only in third embodiment of the present invention and in some other embodiments there are additional facility like hand operated tap to be also operated along with foot/leg operated valve after their connections. The interlocking is described in third embodiment and foot/leg operated valve can be connected to the Fluid Mixer Taps or Valves (FMT) described in sixth and seventh embodiments of the present invention. In some embodiments the innovative Taptee T or Toupling C are used for connection of main body of the present invention FMT to input water supply lines. In some other embodiments the main body is designed and described to be directly connected to input water supply lines without the use of the Taptee T or Toupling C.

First to Eighth embodiments of the present invention Fluid Mixer Tap or Valve (FMT) as described in FIG. 1 to FIG. 11 respectively comprises mainly a main body connected either to a Toupling C or a Taptee T. Ninth to Twelfth embodiments of the present invention Fluid Mixer Tap or Valve (FMT) as described in FIG. 12 to FIG. 13 respectively comprises only one body which is thought of and developed to provide mixing facility in a single body for connection to elbows or tees or any other suitable pipe fittings for cold and hot water or/and raw water separately in cases where there are two/three tap bodies and two/three input legs or tails respectively. There are plurality of legs or tails for connection to hot water supply line, cold water supply line and/or raw water supply line. In the further embodiments lower portion of the inner leg in first to eighth embodiment can be similar to that described in this embodiment and shown in the FIG. 21.

The present invention, Fluid Mixer Tap or Valve (FMT), is having a plurality of hollow legs or tails connected to a tap body or tap bodies and their respective valve seats as described in various embodiments of the present invention FMT which are not there in the prior arts like single lever ceramic discs cartridge or twin lever water mixer tap etc. Also there is no facility in the prior arts for interlocking of hot and cold water lines in such a way that hot water will come out only after cold water is discharged first as described in the third embodiment of the present invention. If there is no cold water available then hot water will not come out immediately as described in the third embodiment of the present invention. In the prior arts innovative Toupling C and Taptee T are not used which are used in some embodiments of the present invention FMT. Hot and cold water supply lines, in prior art mixer taps, are connected through two female threaded sockets at bottom of the tap body using hot/cold steel armoured water hose connectors. Since in the prior arts there are no plurality of legs or tails as integral part of the tap body/bodies so they can not be directly connected to pipe fittings like elbow or tee joints and can not be fitted on surface of kitchen sinks, washbasins etc. using a simple back nut. In this invention in some of preferred embodiments at least one leg can be connected if desired directly to pipe fittings like elbow or tee joints which will save money by not purchasing at least one steel armoured hose connector.

Main body of various embodiments described in this present inventions Fluid Mixer Tap or Valve (FMT) mainly comprises tap body/bodies connected to plurality of legs or tails and spout, cartridge/cartridges housed inside the tap body/bodies and tap handle rotatably connected to spindle of the cartridge/cartridges.

The other advantages of present inventions FMT are ease of its installation to a washbasin or kitchen sinks or bathtubs or any other such system using a simple back nut N1 as in first, third, fourth, sixth and eleventh embodiments of the present invention, using simple hose connectors without steel armour body for hot and cold water connection innovative Toupling C or Taptee T screwed to the outer leg of the main body of first to eighth embodiments as per various drawings described in various figures and directly connected to the main body of ninth to twelfth embodiments as per drawings described in various figures, economical in cost and easy to manufacture and installed and sturdy design and can be used in sediment free water also in some embodiments and can be used for well water also in some other embodiments without much trouble.

Third embodiment can be used for preventing scalding injuries and thermal shocks by hot water. Sixth embodiment of the present invention in conjunction with connecting foot/leg operated valve in medical services and hospitals to be operated by hand and/or foot. This will save a lot of water in addition to improving hygiene and in turn a lot of energy. Tenth embodiment is for use where mixing hot, cold and raw water is required in a single body tap. Eleventh embodiment is for use in kitchen sinks, washbasin sinks, bath tubs etc. without using the Taptee T or the Toupling for connection to hot and cold water supply lines. Twelfth embodiment is used as a valve for mixing two types of fluids.

In first embodiment of the present invention FMT when a tap handle is turned water from two concentric legs or tails, one connected to hot water and other to cold water lines, entered in a spout, through a concentric ports in ceramic discs cartridge when their ports are aligned or opened, after mixing them in a mixing chamber. By turning the tap handle, amount of hot and cold water is adjusted there by controlling temperature of mixed discharge water. This embodiment is developed to be fitted in washbasin, kitchen sinks or bath tubs or any such base where leg or tail is to be inserted and to be fitted in the base using a back nut and a washer. The main body A is connected to the Taptee T.

The second embodiment of the present invention FMT is same as the first embodiment with a difference in second leg. In this embodiment second leg is an integral part of the outer leg where as in the first embodiment the second leg is not an integral part of the outer leg but it is a part of the Taptee T screwed in the first leg of the outer leg. The main body B in the second embodiment is connected to the Toupling C.

In the third embodiment of the present invention FMT, two concentric legs or tails are extended at their top end and are connected to valve seats of respective tap bodies which are also connected to each other and their output is connected to a mixer chamber through an interlocking mechanism for hot and cold water supply. Here the cold water line tap handle (right side handle as per FIG. 3) is first turned allowing water to enter in a header there by lifting up one side (right side as per FIG. 3) of a disc by rotating it by its diametrically opposite protrudes axis in one side and lowering the other half portion (left side as per FIG. 3) of the disc in hot water side for allowing hot water to enter in the mixer chamber when hot water tap handle is turned thereby a mixer of hot and cold water is discharged from the tap. In this embodiment if hot water tap handle is opened first then hot water will lift the half portion of the disc which touches a disc seat of a stopper in the header there by not allowing hot water to enter in the spout and hence there no discharge of hot water out of the tap immediately. This will prevent scald injuries and thermal shock due to first opening mistakenly of hot water line tap. It can be used in kitchen sinks, washbasins, bath tubs etc.

The fourth embodiment of the present invention FMT is same as the third embodiment except interlocking mechanism in the header. In this embodiment there is no interlocking mechanism. It can be used in kitchen sinks, washbasins, bath tubs etc.

The main body of the fifth embodiment of the present invention FMT is same as that of fourth embodiment except it has second leg in the outer leg in addition to the first leg and also it has spout bent differently from the fourth embodiment. This can be used in water line for shower or in place of two separate taps for hot and cold water in wash rooms or bath rooms or any other suitable required places.

In the sixth embodiment of the present invention FMT, inner leg is connected to inner valve seat and concentric outer leg is opened directly into the spout, having two chambers one for direct water entering into the spout and other through the tap cartridge. So if this embodiment is fitted in washbasin or kitchen sink etc. and its second leg or tail is connected to a foot/leg valve through hose connector then water can be discharged through this tap either by turning the tap handle by hand or by operating the foot valve by foot. This is a great advantage over any existing foot operated tap/valve. It will improve hygiene condition in hospital in addition to saving water and electricity. This can be used in wash basin, kitchen sinks, washrooms, hospitals, industries etc.

The seventh embodiment of the present invention FMT is same as the sixth embodiment except its outer leg has second leg in addition to the first leg and can be used for places other than directly fitting in washbasin or kitchen sinks or wash tubs.

In the eighth embodiment of the present invention FMT, two concentric legs or tails are connected to valve seats of their respective two tap bodies and their output is connected to a mixing chamber in a header. The second leg is connected to outer leg whose primary leg is screwed with the Toupling C. Here when handles of both taps are turned, mixer of hot and cold water discharged through the tap. It can be used in wash rooms, water lines of shower, industries etc.

In the ninth embodiment of the present invention FMT, two legs or tails are separately connected to valve seat of respective tap bodies and their output is connected to a mixing chamber in a header. In this embodiment both legs are not concentric but are integral part of tap main body and also there is no need of either Toupling C or Taptee T for connection to hot and cold water supply lines. In this embodiment first and second leg can be directly connected to pipe fittings like elbow or tee or any other suitable pipe fittings. Here when handles of both taps are opened, water from two tap bodies mixed in a mixer chamber before discharging through the tap. It can be used in wash rooms, water lines of shower, industries etc.

The tenth embodiment of the present invention is same as the ninth embodiment except it has one more tap body connected to one more leg or tail in the outer leg and header. The mixing chamber in the header is same for all these three tap bodies. Here when all three taps' handles are opened a mixed water discharges through the tap. It can be used in wash rooms, water lines of shower, industries etc.

The eleventh embodiment of the present invention is same as the main body A of the first embodiment except a minor changes in the concentric inner and outer leg. The inner leg is bent at its bottom end and extrudes through the outer leg in radial direction. It serves as second leg. The first leg is bottom part of the outer leg. Inner leg and outer leg are supported by supporting plates in radial direction. It does not use Taptee T or the Toupling T for connection to hot and cold water supply lines. Mixed water is discharged when the tap handle is turned. It is fitted easily to surface of kitchen sinks, washbasins, bath tubs etc. by using simple back nut. It can be used in kitchen sinks, bath tubs, washbasin etc.

The twelfth embodiment of the present invention is same as the eleventh embodiment except a small changes in its concentric inner and outer leg and a change in the spout. The inner and outer legs are bent at its bottom end for connection to hot and cold water lines. The spout is also designed for outer connection to other system. It does not use Taptee T or the Toupling T for connection to hot and cold water supply lines. Mixed water is discharged when the tap handle is turned. It is fitted easily to pipe line systems. It can be used in industries, shower etc.

The innovative Toupling C is disclosed having one end female threaded and other end male threaded with disc seat inside the body near male threaded end.

The innovative Taptee T is disclosed having one end female threaded and other two end male threaded with disc seat inside the body near male threaded end.

### 4. BRIEF DESCRIPTION OF THE DRAWING

The symbols, detailed descriptions and various embodiments of the present invention are shown in the various drawings as detailed below:

Preferred embodiments of the present invention Fluid Mixer Taps or Valves (FMT) are illustrated in the accompanying drawings as follows:

FIG. 1 is partly cross-sectional view and partly perspective view of first embodiment of the present invention Fluid Mixer Tap (FMT).

FIG. 2 is partly cross-sectional view and partly perspective view of second embodiment of the present invention Fluid Mixer Tap (FMT).

FIG. 3 is partly cross-sectional view and partly perspective view of third embodiment of the present invention Fluid Mixer Tap (FMT).

FIG. 4 is partly cross-sectional view and partly perspective view of main body D of the third embodiment of the present invention Fluid Mixer Tap (FMT).

FIG. 5 is partly cross-sectional view and partly perspective view of main body E without taptee T in fourth embodiment of the present invention Fluid Mixer Tap (FMT).

FIG. 6 is partly cross-sectional view and partly perspective view of fifth embodiment of the present invention Fluid Mixer Tap (FMT).

FIG. 7 is partly cross-sectional view and partly perspective view of main body F of the fifth embodiment of the present invention Fluid Mixer Tap (FMT).

FIG. 8 is partly cross-sectional view and partly perspective view of sixth embodiment of the present invention Fluid Mixer Tap (FMT).

FIG. 9 is partly cross-sectional view and partly perspective view of main body A′ of the sixth embodiment of the present invention Fluid Mixer Tap (FMT).

FIG. 10 is partly cross-sectional view and partly perspective view of seventh embodiment of the present invention Fluid Mixer Tap (FMT).

FIG. 11 is partly cross-sectional view and partly perspective view of eighth embodiment of the present invention Fluid Mixer Tap (FMT).

FIG. 12(a) is partly cross-sectional view and partly perspective view of ninth embodiment of the present invention Fluid Mixer Tap (FMT).

FIG. 12(b) is partly cross-sectional view and partly perspective view at a cross section X-X′ in the FIG. 12(a) of the ninth embodiment of the present invention Fluid Mixer Tap (FMT).

FIG. 13 is partly cross-sectional view and partly perspective view of tenth embodiment of the present invention Fluid Mixer Tap (FMT).

FIG. 14 is partly cross-sectional view and partly perspective view at a cross-section X-X′ in the FIG. 13 of the tenth embodiment of the present invention Fluid Mixer Tap (FMT).

FIG. 15 is partly cross-sectional view and partly perspective view of eleventh embodiment of the present invention Fluid Mixer Tap (FMT).

FIG. 16 is partly cross-sectional view and partly perspective view of twelfth embodiment of the present invention Fluid Mixer Tap (FMT).

FIG. 17(a) is a cross-sectional view of Taptee T of the present invention Fluid Mixer Tap

(FMT).

FIG. 17(b) is a perspective view of the Taptee T of the present invention Fluid Mixer Tap (FMT).

FIG. 18(a) is a cross-sectional view of Toupling C of the present invention Fluid Mixer Tap (FMT).

FIG. 18(b) is a perspective view of the Toupling C of the present invention Fluid Mixer Tap (FMT).

FIG. 19(a) is a perspective view of a header disc 8a used in the third embodiment of the present invention Fluid Mixer Tap (FMT).

FIG. 19(b) is a perspective view of a hollow disc Z1 used in some embodiments of the present invention Fluid Mixer Tap (FMT).

FIG. 19(c) is a perspective view of a cylindrical head lock nut N2 used in some embodiments of the present invention Fluid Mixer Tap (FMT).

FIG. 19(d) is a perspective view of a lock nut N1 used in some embodiments of the present invention Fluid Mixer Tap (FMT).

FIG. 19(e) is a perspective view of a header disc seat body L1 used in the third embodiment of the present invention Fluid Mixer Tap (FMT).

FIG. 19(f) is a perspective view of a stopper M1 for the header disc 8a used in the third embodiment of the present invention Fluid Mixer Tap (FMT).

FIG. 20(a) is a perspective view of a ceramic disc tap cartridge or valve assembly 3 used in some embodiments of the present invention Fluid Mixer Tap (FMT).

FIG. 20(b) is a bottom perspective view of the ceramic disc tap cartridge or valve assembly 3 when ports 3g and 3h are in closed position used in some embodiments of the present invention Fluid Mixer Tap (FMT).

FIG. 20(c) is a perspective view of a lower ceramic disc (fixed) K2 in the ceramic disc tap cartridge or valve assembly 3 used in some embodiments of the present invention Fluid Mixer Tap (FMT).

FIG. 20(d) is a perspective view of a upper ceramic disc (moving) K1 in the ceramic disc tap cartridge or valve assembly 3 used in some embodiments of the present invention Fluid Mixer Tap (FMT).

FIG. 21 is a cross-sectional view of inner leg 8z and can be used in place of inner leg of main body A or B or A′ or B′ or D or E or F or G of the present invention Fluid Mixer Tap (FMT).

### 5. KEY TO ILLUSTRATIONS

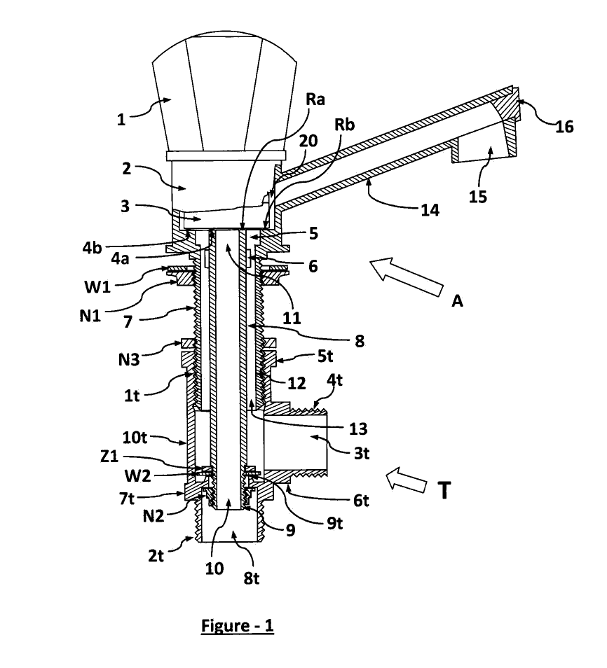

### Ref: FIG. 1 to FIG. 16

A. Main body of First Embodiment of the present invention Fluid Mixer Tap (FMT).
B. Main body of Second Embodiment of the present invention Fluid Mixer Tap (FMT).
D. Main body of Third Embodiment of the present invention Fluid Mixer Tap (FMT).
E. Main body of Fourth Embodiment of the present invention Fluid Mixer Tap (FMT).
F. Main body of Fifth Embodiment of the present invention Fluid Mixer Tap (FMT).
A′. Main body of Sixth Embodiment of the present invention Fluid Mixer Tap (FMT).
B′. Main body of Seventh Embodiment of the present invention Fluid Mixer Tap (FMT).
G. Main body of Eighth Embodiment of the present invention Fluid Mixer Tap (FMT).
H. Main body of Ninth Embodiment of the present invention Fluid Mixer Tap (FMT) is also the Ninth Embodiment of the present invention Fluid Mixer Tap (FMT) .
M. Main body of Tenth Embodiment of the present invention Fluid Mixer Tap (FMT) is also the Tenth Embodiment of the present invention Fluid Mixer Tap (FMT).
A″. Main body of Eleventh Embodiment of the present invention Fluid Mixer Tap (FMT) is also the Eleventh Embodiment of the present invention Fluid Mixer Tap (FMT).
A′″. Main body of Twelfth Embodiment of the present invention Fluid Mixer Tap (FMT) is also the Twelfth Embodiment of the present invention Fluid Mixer Tap (FMT).
a1. Aerator
N3. Hex nut
W1. Rubber washer
W2. Rubber washer
W3. Seat or retaining washer of tap cartridge 3ax, 3ay, 3b, 3dx, 3dy, 3ex, 3ey or 3ez (spindle-washers or PVC cartridge or brass or ceramic discs cartridge or mono block cartridge or PVC cartridge etc.)
W4. Rubber washer

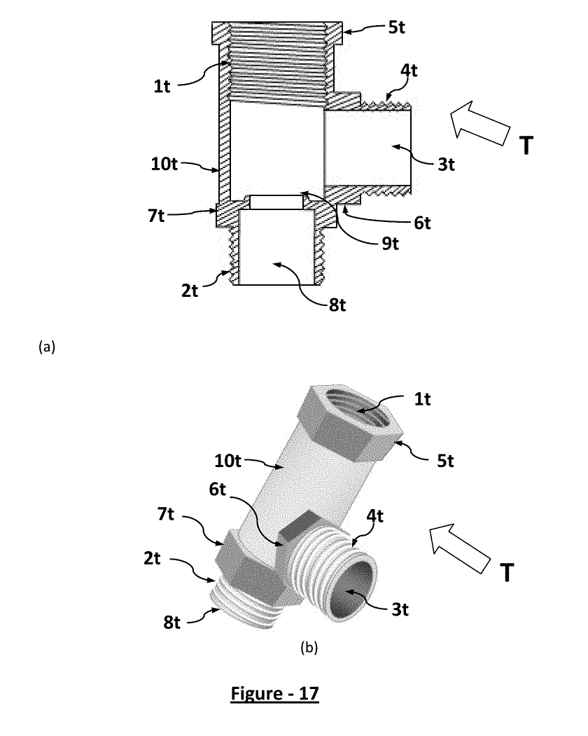

### Ref: FIG. 17

FIG. 17 is a cross-sectional view and perspective view of the Taptee T of the present invention Fluid Mixer Tap (FMT). It is connected to the main body of the First, Third, Fourth and Sixth embodiment of the present invention FMT.
T. Taptee for connecting the main body A, D, E, A′
1t. Female threaded socket end of the Taptee T
2t. First leg with outer threaded surface end of the Taptee T
3t. Inlet to second leg 4t of the Taptee T
4t. Second leg with outer threaded surface of the Taptee T
5t. Hexagonal edge near the 1t of the Taptee T
6t. Hexagonal edge near the 4t of the Taptee T
7t. Hexagonal edge near the 2t of the Taptee T
8t. Inlet to the first leg 2t of the Taptee T
9t. Disc seat or valve seat of the Taptee T
10t. Body of the Taptee T

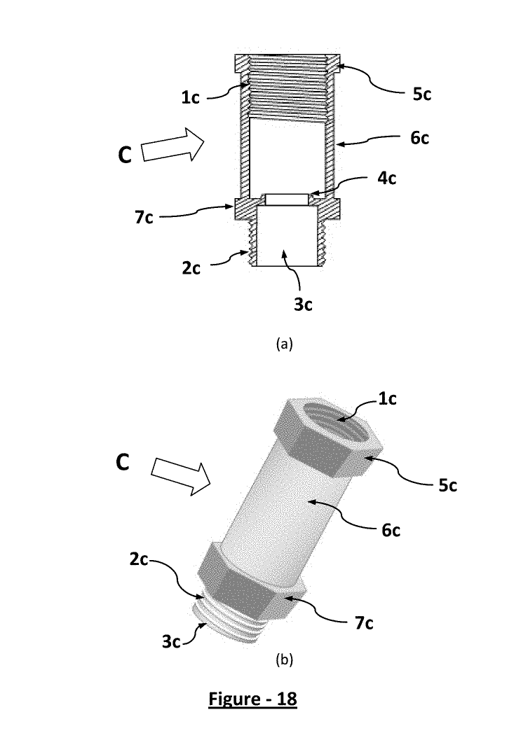

### Ref: FIG. 18

FIG. 18 is a cross-sectional view and perspective view of the Toupling C of the present invention Fluid Mixer Tap (FMT). It is connected to the main body of the Second, Fifth, Seventh and Eighth embodiment of the present invention FMT.
C. Toupling for connecting to the main body B, F, B′, G
1c. Female threaded socket end of the Toupling C
2c. Male threaded end of the Toupling C
3c. Inlet to the male threaded end 2c
4c. Disc seat or valve seat of the Toupling C
5c. Hexagonal edge near the 1c of the Toupling C
6c. Body of the Toupling C
7c. Hexagonal edge near the 2c of the Toupling C

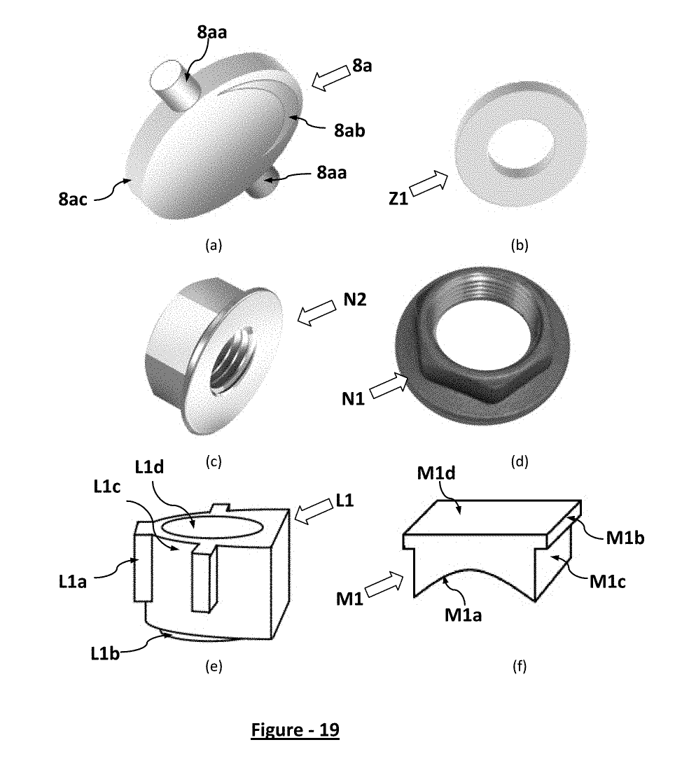

### Ref: FIG. 19

FIG. 19 perspective view of a header disc 8a, hollow disc Z1, lock nut N2, back nut N1, header disc seat body L1 and stopper M1 used in various embodiments of the present invention FMT.
8a. Header disc
8aa. Cylindrical protrudes/edges in disc 8ac
8ab. Additional weight in disc 8ac
8ac. Disc
Z1. Hollow disc
N2. Cylinder head lock nut
N1. Back Nut
L1. Header disc seat body
L1a. Protrudes in the L1
L1b. Disc seat or valve seat in the L1
L1c. Outer surface of the L1
L1d. Inner opening in the L1
M1. Stopper for header disc 8a
M1a. Curved lower surface of the M1
M1b. Edges in the M1
M1c. Side surface of the M1
M1d. Top plane surface of the M1

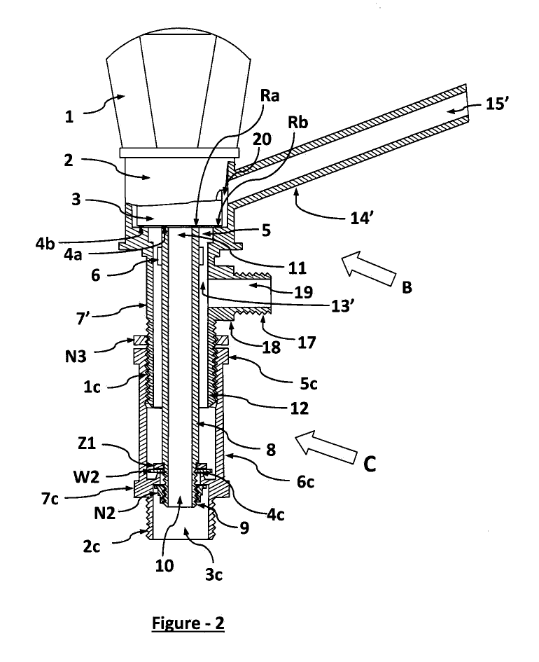

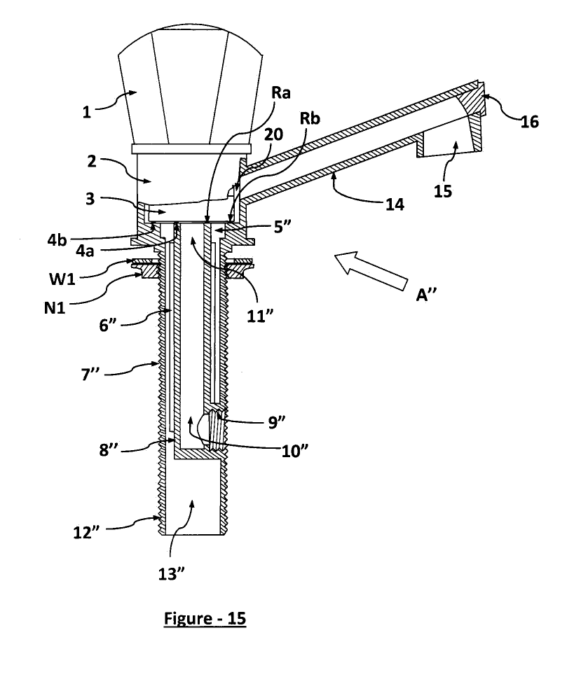

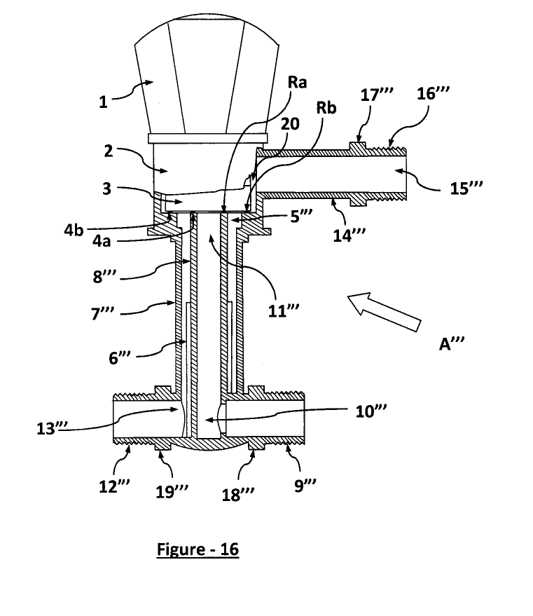

### Ref: FIG. 1 to FIG. 2, FIG. 15, FIG. 16, FIG. 17 to FIG. 21

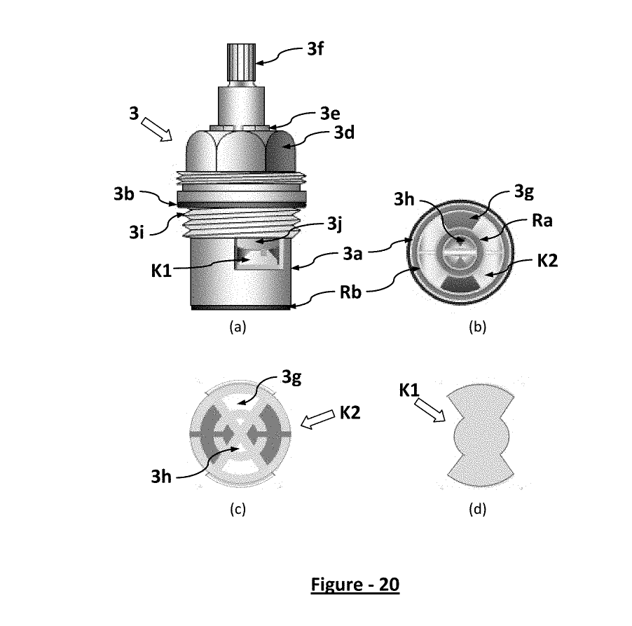

FIG. 1 shows partly cross sectional view and partly perspective view of the main body A and cross sectional view of the Taptee T screwed in the main body A. FIG. 2 shows the partly cross sectional view and partly perspective view of the main body B and cross sectional view of the Toupling C screwed in the main body B. FIG. 15 shows partly cross sectional view of the eleventh embodiment A″ of the present invention FMT.
1. Tap handle
2. Tap body
3. Tap cartridge or valve assembly (spindle-washers or PVC or brass or ceramic discs or mono block ceramic disc cartridges etc.) shown in the FIG. 20
3a. Body of the tap cartridge 3
3b. O-ring
3d. Valve retaining nut
3e. Circlip
3f. Stem or spindle
3g. Outer port
3h. Inner port
3i. Threads
3j. Catcher for upper ceramic disc K1
K1. Upper ceramic disc (moving) for tap cartridge 3
K2. Lower ceramic disc (fixed) for tap cartridge 3
Ra. Inner retaining washer or O-ring for tap cartridge 3
Rb. Outer retaining washer or O-ring for tap cartridge 3
4a. Inner valve seat
4b. Outer valve seat
5. Outlet for outer tail 7
6. Connecting plates in radial direction between inner tail 8 and outer tail 7
7. Threaded outer tail or leg of the main body A
8. Inner tail or leg of the A
9. Threaded bottom end of the inner tail or leg 8
10. Inlet to the inner tail 8
11. Outlet for the inner tail 8
12. First leg or tail in the outer tail 7 of the A in FIG. 1 or First leg or tail in outer leg or tail 7′ of the B in FIG. 2
13. Inlet to the outer tail 7
14. Spout of the main body A or the main body A″
15. Outlet of the spout 14
16. End cap in the spout 14
17. Second tail or leg in outer tail or leg 7′ of the main body B
18. Hexagonal edge in the second leg 17
19. Inlet to the second leg 17
20. Mixing chamber
7′. Outer leg or tail of the B
13′. Inlet to the outer leg 7′
14′. Spout of the B
15′. Outlet of the spout 14′
5″. Outlet for outer tail or leg 7″ of the main body A″
6″. Connecting plates in radial direction between inner tail or leg 8″ and outer tail or leg 7″
7″. Threaded outer tail or leg of the A″
8″. Inner tail or leg of the A″
9″. Second leg or tail having female threaded socket extruded from the inner leg 8″ of the A″
10″. Inlet to the inner tail 8″
11″. Outlet for the inner tail 8″
12″. First leg or tail in the outer tail 7″ of the A″ in FIG. 15
13″. Inlet to the outer tail 7″

5″′. Outlet for outer tail or leg 7″′. of the main body A″′ of the Twelfth embodiment of the present invention FMT
6″′. Connecting plates in radial direction between inner tail or leg 8″′ and outer tail or leg 7″′
7″′. Outer tail or leg of the A″′
8″′. Inner tail or leg of the A″′
9″′. Second leg or tail connected to the inner leg 8″′ of the A″′ for flow of fluids
10″′. Inlet to the inner tail 8″′ through the second leg 9″′
11″′. Outlet for the inner tail 8″′
12″′. First leg or tail connected to the outer tail 7″ of the A″ for flow of fluids as shown in the FIG. 16
13″′. Inlet to the outer tail 7″′ through the first leg 12″′
14″′. header of the main body A″′
15″′. Outlet for the outlet header 14″′ through threaded end outlet 16″′
16″′. Threaded end outlet of the header 14″′
17″′. Hexagonal edge in the header 14″′
18″′. Hexagonal edge in the second leg 9″′
19″′. Hexagonal edge in the first leg 12″′

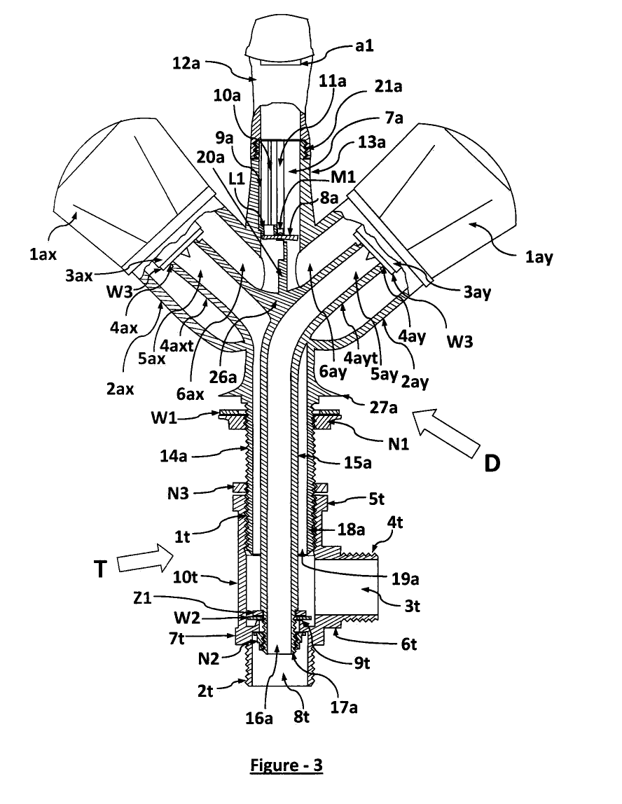

### Ref: FIG. 3 to FIG. 7, FIG. 17 to FIG. 19

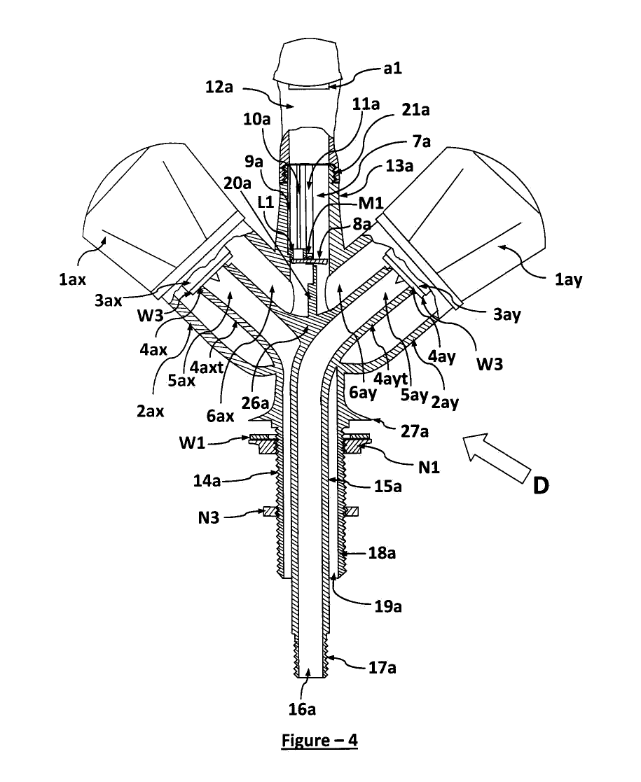

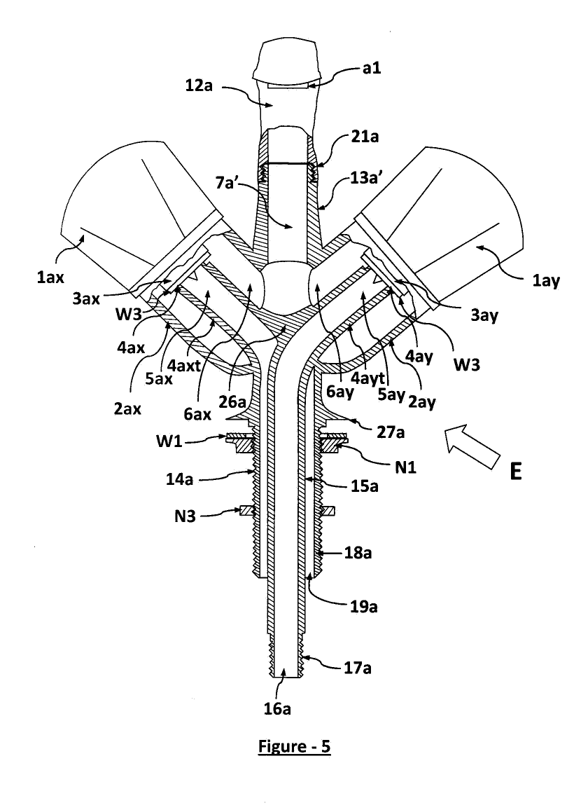

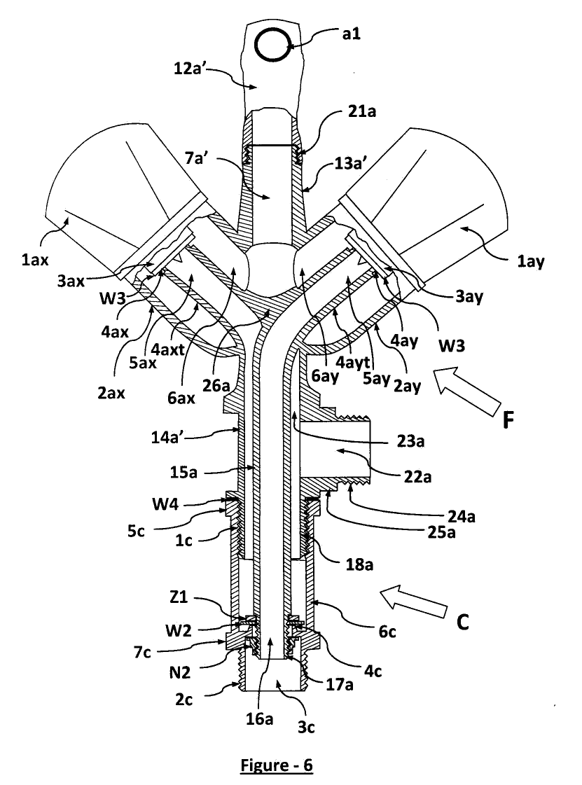

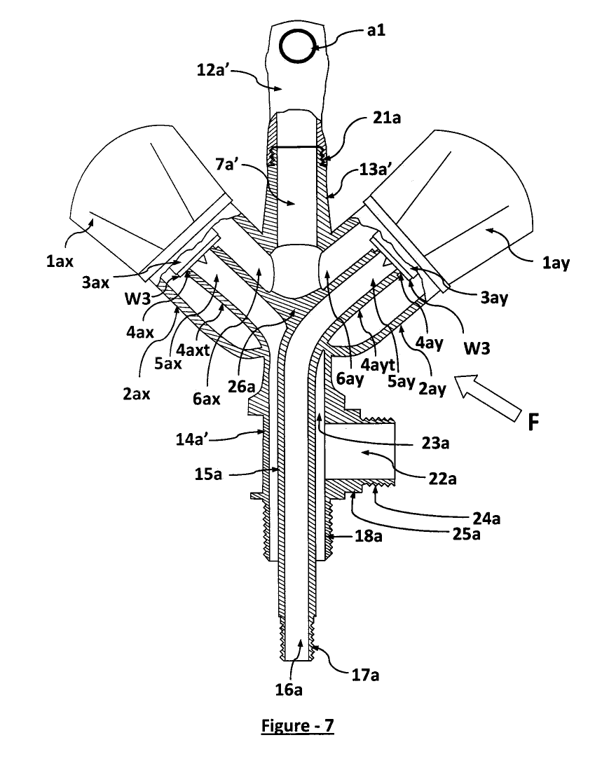

FIG. 3 shows partly cross sectional view and partly perspective view of the main body D and cross sectional view of the Taptee T screwed in the main body D. FIG. 4 shows partly cross sectional view and partly perspective view of the main body D. FIG. 5 shows partly cross sectional view and partly perspective view of the main body E. Here connection of the main body E with the Taptee T is not shown but it will be connected to the Taptee T. FIG. 6 shows the partly cross sectional view and partly perspective view of the main body F and cross sectional view of the Toupling C screwed in the main body F. FIG. 7 shows partly cross sectional view and partly perspective view of the main body F.
1ax. Tap handle
2ax. Tap body
3ax. Tap cartridge or valve assembly (spindle-washer or PVC or brass or ceramic discs or mono block cartridges etc.)
4ax. Valve seat
4axt. Valve seat tube
5ax. Outlet for outer leg or tail 14a
6ax. Outlet to the tap body 2ax
1ay. Tap handle
2ay. Tap body
3ay. Tap cartridge or valve assembly (spindle-washer or PVC or brass or ceramic discs or mono block cartridges etc.)
4ay. Valve seat
4ayt. Valve seat tube
5ay. Outlet for Inner leg or tail 15a
6ay. Outlet to the tap body 2ay
7a. Mixing chamber
8a. Header disc
9a. Groove inside header 13a for the header disc seat body L1
10a. Grooves inside header 13a for the L1
11a. Grooves inside header 13a for the stopper M1
12a. Spout of the main body D or E
13a. Header of the D
14a. Threaded outer leg or tail of the D or the E
15a. Inner leg or tail of the main body D or the E or the F
16a. Inlet to the inner leg 15a
17a. Threaded end of the inner tail or leg 15a
18a. First leg or tail in the outer tail 14a of the D or the E or First leg or tail in outer tail
14a′ of the F
19a. Inlet to the outer tail 14a
20a. Partition wall between left body 2ax and right body 2ay of the D
21a. Threaded end of the header 13a or header 13a
22a. Inlet to second leg 24a of the outer leg 14a′ of the main body F
23a. Inlet to outer leg 14a′
24a. Second tail or leg in outer tail or leg 14a′ of the main body F
25a. Hexagonal edge in the second leg 24a
26a. Connecting plate or means
27a. Base or Protrude in the outer leg 14a
7a′ Mixing chamber in header 13a′ of the F
12a′. Spout of the F
13a′. Header of the main body F
14a′. Outer leg or tail of the main body F

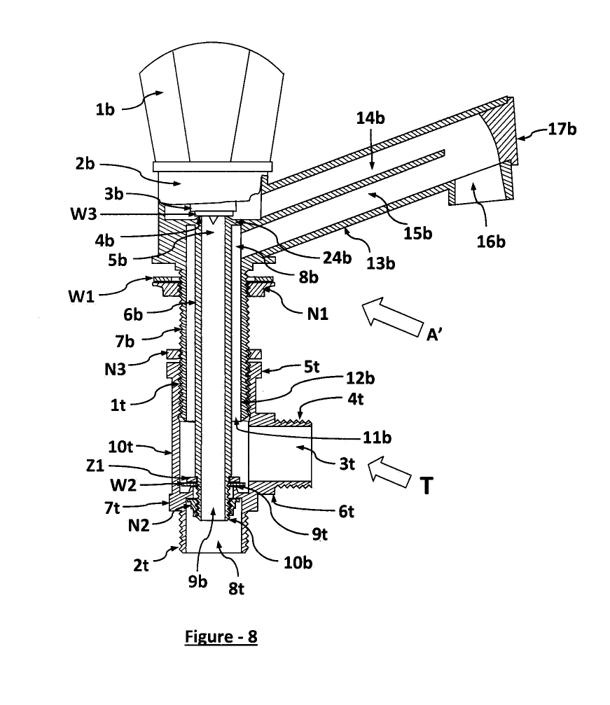

### Ref: FIG. 8 to FIG. 10, FIG. 17 to FIG. 19

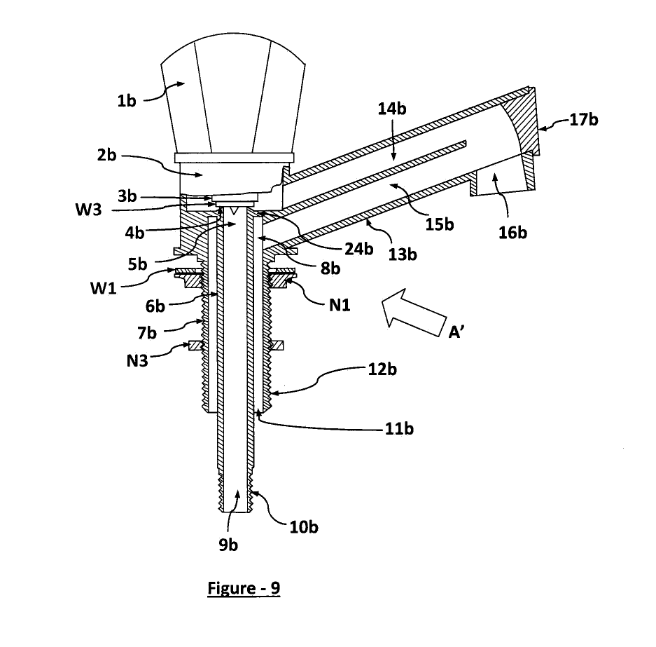

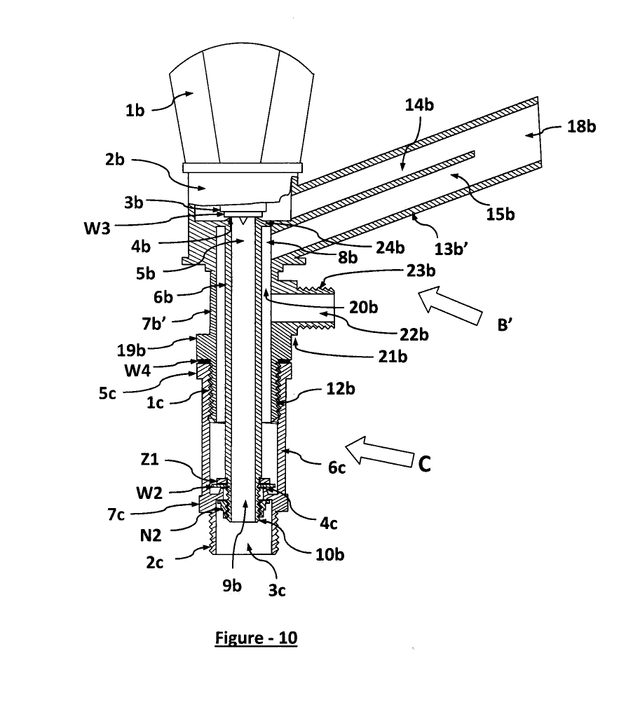

FIG. 8 shows partly cross sectional view and partly perspective view of the main body A′ and cross sectional view of the Taptee T screwed in the main body A′. FIG. 9 shows partly cross sectional view and partly perspective view of the main body A′. FIG. 10 shows partly cross sectional view and partly perspective view of the main body B′ and cross sectional view of the Toupling C screwed in the main body B′.
1b. Tap handle
2b. Tap body
3b. Tap cartridge or valve assembly (spindle-washer or PVC or brass or ceramic discs or mono block cartridges etc.)
4b. Valve seat
5b. Outlet to inner tail or leg 6b of the main body A′
6b. Inner tail or leg of the A′
7b. Threaded outer tail or leg of the A′
8b. Outlet to the outer tail 7b of the main body A′ or outer tail 7b′ of the main body B′
9b. Inlet to the inner tail 6b
10b. Threaded end of the inner tail 6b
11b. Inlet to the outer leg 7b of the main body A′
12b. First leg of the outer leg 7b
13b. Spout of the A′
14b. Upper tube or hollow pipe in the spout 13b of the main body A′ or spout 13b′ of the main body B′ for connecting the inner leg 6b through the cartridge 3b for flow of water or other fluids
15b. Lower tube for connection to the outer leg 7b of the A′ or outer leg 7b′ of the B′ through the outlet 8b
16b. Mixing chamber or outlet of the spout 13b of the A′
17b. End cap connected to the spout 13b of the A′
18b. Mixing chamber or outlet of spout 13b′ of the B′
19b. Hexagonal edge near the first leg 12b of outer leg or tail 7b′ of the B′
20b. Inlet to outer leg 7b′ through second leg 23b of the outer leg 7b′
21b. Hexagonal edge in the second leg 23b of outer leg or tail 7b′
22b. Inlet to second leg 23b of the B′
23b. Second leg or tail of outer leg or tail 7b′
24b. Connecting plate or means for connection to upper end of the inner leg 6b to the upper end of the outer leg 7b of the A′ or 7b′ of the B′
7b′. Outer leg or tail of the main body B′
13b′ Spout of the main body B′

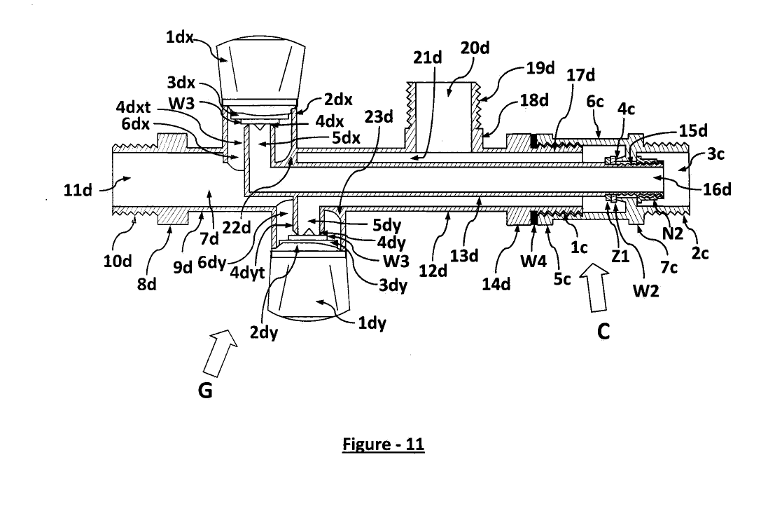

### Ref: FIG. 11, FIG. 18 to FIG. 19

FIG. 11 shows partly cross sectional view and partly perspective view of the main body G and cross sectional view of the Toupling C screwed in the main body G.
1dx. Tap handle
2dx. Tap body
3dx. Tap cartridge or valve assembly (spindle-washer or PVC or brass or ceramic discs or mono block cartridges etc.)
4dx. Valve seat
4dxt. Valve seat tube
5dx. Outlet for inner leg or tail 13d
6dx. Outlet to the tap body 2dx
1dy. Tap handle
2dy. Tap body
3dy. Tap cartridge or valve assembly (spindle-washer or PVC or brass or ceramic discs or mono block cartridges etc.)
4dy. Valve seat
4dyt. Valve seat tube
5dy. Outlet for outer leg or tail 12d
6dy. Outlet to the tap body 2dy
7d. Mixing chamber
8d. Hexagonal edge in header 9d
9d. Header of the main body G
10d. Threaded end outlet of the header 9d
11d. Outlet of the main body G
12d. Outer leg or tail of the main body G
13d. Inner leg or tail of the main body G
14d. Hexagonal edge in the outer leg 12d near first leg or tail 17d
15d. Threaded end of the inner leg 13d
16d. Inlet to the inner leg 13d
17d. First leg or tail of the outer leg 12d
18d. Hexagonal edge in second leg 19d of the outer leg 12d
19d. Second leg or tail of the outer leg 12d
20d. Inlet to the second leg 19d
21d. Inlet to the outer leg 12d through second leg 19d
22d. Connecting plate or means
23d. Connecting plate or means

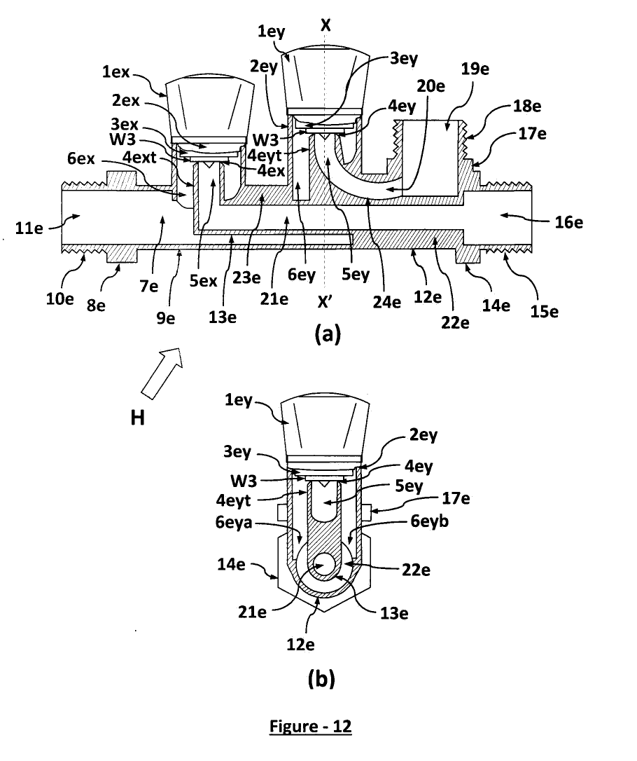

### Ref: FIG. 12 to FIG. 14

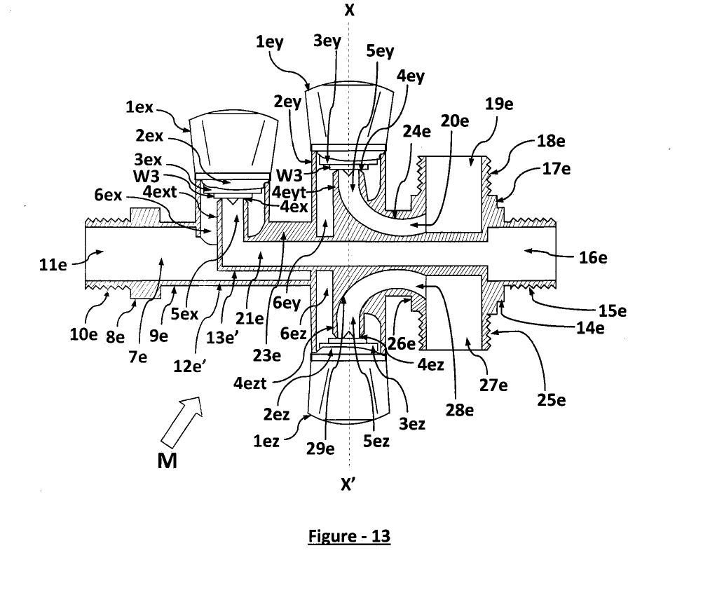

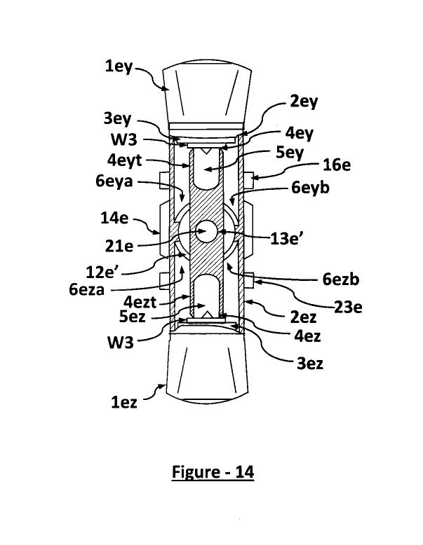

FIG. 12(a) shows partly cross sectional view and partly perspective view of the main body H which is also ninth embodiment of the present invention FMT. FIG. 12(b) is partly cross-sectional view and partly perspective view at a cross section X-X′ in the FIG. 12(a) of the ninth embodiment of the present invention Fluid Mixer Tap (FMT). FIG. 13 shows partly cross sectional view and partly perspective view of the main body M which is also tenth embodiment of the present invention FMT. FIG. 14 is partly cross-sectional view and partly perspective view at a cross-section X-X′ in the FIG. 13 of the tenth embodiment of the present invention Fluid Mixer Tap (FMT).
1ex. Tap handle
2ex. Tap body
3ex. Tap cartridge or valve assembly (spindle-washer or PVC or brass or ceramic discs or mono block cartridges etc.)
4ex. Valve seat
4ext. Valve seat tube
5ex. Outlet for inner leg or tail 13e of the main body H or outlet for inner leg or tail 13e′ of the main body M extrudes to primary leg 15e
6ex. Outlet to the tap body 2ex opened into mixing chamber 7e
1ey. Tap handle
2ey. Tap body
3ey. Tap cartridge or valve assembly (spindle-washer or PVC or brass or ceramic discs or mono block cartridges etc.)
4ey. Valve seat
4eyt. Valve seat tube
5ey. Outlet of inlet leg or tail 24e of the tap body 2ey
6ey. Outlet of the tap body 2ey extended to left outlet 6eya and to right outlet 6eyb
6eya. Left side outlet of the tap body 2ey opened into mixing chamber 7e
6eyb. Right side outlet of the tap body 2ey opened into mixing chamber 7e
1ez. Tap handle
2ez. Tap body
3ez. Tap cartridge or valve assembly (spindle-washer or PVC or brass or ceramic discs or mono block cartridges etc.)
4ez. Valve seat
4ezt. Valve seat tube
5ez. Outlet of inlet leg or tail 29e
6ez. Outlet of the tap body 2ez extended to left outlet 6eza and to right outlet 6ezb
6eza. Left side outlet of the tap body 2ez opened into mixing chamber 7e
6ezb. Right side outlet of the tap body 2ez opened into mixing chamber 7e
7e. Mixing chamber
8e. Hexagonal edge in header 9e
9e. Header of the main body H or the M
10e. Threaded outlet end of the header 9e for connection to hose connector or pipe fittings
11e. Outlet of the H or M
12e. Outer body or tail of the H
13e. Inner leg or tail of the H extrudes to first leg 15e
14e. Hexagonal edge in first leg 15e
15e. First leg or tail of the H or the M
16e. Inlet to the first leg 15e
17e. Hexagonal edge in second leg 18e
18e. Second leg or tail of the H or the M
19e. Inlet to the second leg 18e
20e. Inlet to the inlet leg 5ey
21e. Inside of the inner leg 13e of the main body H or 13e′ of the main body M
22e. Connecting plate between the outer body 12e and inner leg 13e of the H
23e. Connecting plate between the outer leg 12e and inner leg 13e of the H or Connecting plate between the outer leg 12e′ and inner leg 13e′ of the M
24e. Inlet leg or tail of the tap body 2ey
25e. Third leg or tail of the M
26e. Hexagonal edge in the third leg 25e
27e. Inlet to the third leg 25e
28e. Inlet to the inlet leg 29e
29e. Inlet leg or tail of the tap body 2ez
12e′. Outer body or tail of the M
13e′. Inner leg or tail of the M

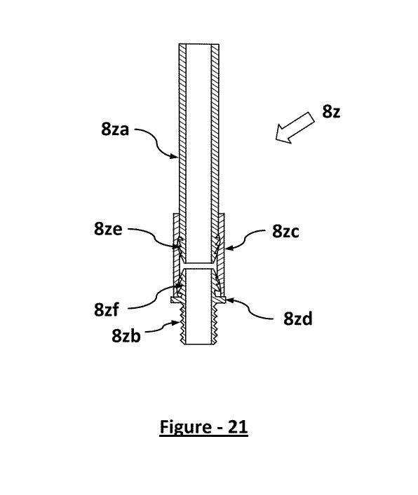

### Ref: FIG. 21

FIG. 21 shows partly cross sectional view and partly perspective view of the inner leg which can be in other embodiments which are not disclosed here of the present invention Fluid Mixer Tap (FMT).
8z. Lower portion of the inner leg for the main body A or the B or the A′ or the B′ or the D or the E or the F or the G without hollow disc Z1
8za. Upper portion of the 8z with hose barb tube 8ze having tapered stub with ridges at its bottom end
8zb. Lower portion of the 8z with hose barb tube 8zf at the top, and male pipe threads at the bottom and disc protrude 8zd
8zc. Flexible hose pipe connecting the upper portion 8za and the lower portion 8zb by inserting it into hose barbs 8ze and 8zf
8zd. Disc protrude in the lower portion 8zb
8ze. Hose barb at bottom end in the upper portion 8za
8zf. Hose barb at top end in the lower portion 8zb

### 6. DETAILS DESCRIPTION OF THE INVENTION

There are twelve embodiments and further embodiments disclosed in the present invention Fluid Mixer Taps or Valves (FMT) which are developed for use in baths, kitchen sinks, wash area, bath tubs, industries, hospitals etc. according to respective embodiments and attachable to them for delivery of mixed water/fluids. The Fluid Mixer Tap or Valves (FMT) comprises, in the First to Eighth embodiments of the present invention, two main parts in each embodiment one is a main body and the other is either a Toupling C or a Taptee T connected to the main body as per various drawings in FIG. 1 to FIG. 11 and in the ninth to twelfth embodiments neither Toupling C nor Taptee T is required to be attached to the main body wherein there is only one body which is thought of and developed to provide mixing facility in a single body for connection to elbows or tees or any other suitable pipe fittings for cold and hot water or/and raw water separately in cases where there are two/three tap bodies and two/three input legs or tails respectively. There are plurality of legs or tails for connection to the hot water supply line and cold water supply line.

FIG. 17(a) and 17(b) describe the Taptee T. FIG. 17(a) and FIG. 17(b) shows a cross sectional view and a perspective view respectively of the Taptee T. The taptee T is an innovative tap fittings comprises tubular female threaded end or leg 1t with a hexagonal edge 5t, a first tubular male leg or tail 2t with a hexagonal edge 7t and a second tubular leg or tail 4t with a hexagonal edge 6t connected to a hollow body 10t of the taptee T. There is one tubular disc seat 9t inside the taptee T near the male threaded end 2t. It has inner hollow area for flow of fluid/water from the first leg 2t and the second leg 4t to the female end 1t. The female threaded end 1t of the taptee T is screwed in first leg of the main body A, D, E and A′ described in the 1^{st}, 3^{rd}, 4^{th} and 6^{th} embodiments respectively of the present invention Fluid Mixer Tap or Valve (FMT). The first leg 2t and the second leg 4t are connected to pipe fittings like hose pipe, elbow or tee joint or any other suitable pipe fittings for connection to hot and cold water supply lines directly or through female ends hose pipe connectors.

FIG. 19(a) and FIG. 18(b) describe the Toupling C. FIG. 18(a) and FIG. 18(b) shows cross sectional view and a perspective view respectively of the Toupling C. The toupling C is an innovative tap fittings comprises a tubular female threaded end or leg 1c with a hexagonal edge 5c, a first tubular male threaded end or leg 2c with a hexagonal edge 7c connected to opposite end of a body 6c of the toupling C. There is one tubular disc seat 4c inside the toupling C near the male threaded end 7c inside the toupling C. It has inner hollow area for flow of fluid/water from the male end 2c to the female end 1c. The female threaded end 1c of the toupling C is screwed in first leg of the main body B, F, B′ and G described in the 2^{nd}, 5^{th}, 7^{th} and 8^{th} embodiments respectively of the present invention Fluid Mixer Taps (FMT). The first leg 2c is connected to pipe fittings like hose pipes, elbow or tee joint or any other suitable pipe fittings for connection to the hot or cold water supply lines directly or through female ends hose pipe connector.

FIG. 19(a), (e) and (f) describe parts /elements/objects of interlocking mechanism used in the Third Embodiment of the present invention Fluid Mixer Tap or Valve (FMT). Interlocking mechanism substantially comprises a header disc 8a, a stopper M1 and a header disc body L1 fitted in the header 13a of third embodiment of the present invention FMT as shown in the FIG. 3.

FIG. 19(a) describes a header disc 8a. FIG. 19(a) shows a view of the header disc 8a comprises two coaxial cylindrical protrudes 8aa in opposite lateral surface of the disc 8ac. An extra weight 8ab is added in bottom surface of the disc 8ac for unbalance in weight in two sides of the disc 8ac with respect to the line joining the two protrudes 8aa. This additional weight 8ab is required so that the disc 8ac will be in a position touching the header disc seat L1b of the header disc seat body L1 when there is no flow of water from a tap towards additional weight 8ab end. The opposite protrudes 8aa are inserted in the opposite grooves 11a in the header 13a such that the disc 8ac rotates about the central axis of the protrudes 8aa as shown in the FIG. 3 in the third embodiment of the present invention FMT. To prevent the disc 8a to come out from its position stopper M1 is fitted in the groove 11a in the header 13a.

FIG. 19(e) describes the header disc seat body L1. FIG. 19(e) is a view of the header disc seat body L1. The body L1 comprises three protrudes L1a in its curved/semi circular outer surface L1c, a cylindrical hole L1d and a disc seat L1b in the lower surface. The body L1 is inserted in grooves 9a and 10a in the header 13a in the FIG. 3 and fitted at a location where upper left side of the disc 8ac touches the disc seat L1b and free to moves down.

FIG. 19(f) describes the stopper M1. FIG. 19(f) shows a view of the stopper M1. The stopper M1 comprises a flat top surface M1d, two opposite side edges M1b, two opposite side surface M1c and a curved bottom surface M1a. The curved bottom surface M1a is kept just above the lateral surface of the protrude 8aa when fitted in the header. For the two protrudes 8aa, the two stoppers M1 are used and fitted in two opposite grooves 11a of the header 13a in the FIG. 3.

FIG. 19(b) describes and shows a hollow disc Z1. FIG. 19(c) describes and shows a cylinder head nut N2. FIG. 19(d) describes and shows a back nut N1.

FIG. 20(a) describes a tap cartridge or valve assembly 3. FIG. 20(a) shows a view of a tap cartridge or valve assembly 3. The tap cartridge 3 is similar to brass body mono block ceramic discs tap cartridge available in the market with only difference is in its lower (fixed) ceramic disc K2 and upper (movable) ceramic disc K1. The lower ceramic disc K2 is having two ports/openings each in inner port 3h and outer concentric port 3g as shown in the FIG. 20(b) and (c). FIG. 20(d) shows a view of the upper disc K1 which rotates when the tap handle 1 rotates. The tap cartridge or valve assembly 3 as shown in the FIG. 20 substantially comprises a body 3a, an O-ring 3b, a valve retaining nut 3d, a circlip 3e, a stem or spindle 3f, the upper (moving) ceramic disc K1, the lower (fixed) ceramic disc K2, the retaining washers or O-rings Ra and Rb. The tap cartridge 3 is same as that of any type of standard tap cartridges suitable to be fixed and used in this first and second embodiment of the present invention as shown in the FIG. 1 and FIG. 2. The cartridge 3 can be spindle-washers type also. In this type of cartridge there can be one washer covering both inner valve seat 4a and outer valve seat 4b or can have two concentric washer designed to suit the requirement in the present invention. The tap cartridge 3 is housed in the tap body 2 and the stem or spindle 3f is tightened to the tap handle 1 by a screw.

FIG. 21 discloses a lower portion of an inner leg 8z having two parts 8za and 8zb. The lower portion 8zb is having hose barb 8zf at top end, circular disc protrude 8zd near middle end and threaded end at bottom side for connection to the lock nut N2. There are various inner legs e.g. 8 in the First and Second embodiment, 15a in the Third to Fifth embodiment, 6b in the Sixth and Seventh embodiment and 13d in the Eighth embodiment of the present invention FMT. Hollow disc Z1 inserted in the above said inner legs in the first to the eighth embodiments. This combination of the inner leg and the disc Z1 can be replaced by the inner leg comprising of the 8za-8ze, the 8zb-8zd-8zf and a connecting pipe 8zc as shown in the FIG. 19. The advantage will be that the chances of breakage of the inner leg as shown in the first to eighth embodiment due to opening of the taptee T or the toupling C from the main body of embodiments shown in FIG. 1 to FIG. 11 without removing the lock nut N2 can be ruled out.

### A. First Embodiment

FIG. 1 describes the First Embodiment of the present invention Fluid Mixer Tap (FMT). Partly cross sectional and partly perspective view of the First Embodiment of the present invention is shown in FIG. 1.

The Fluid Mixer Tap illustrated in FIG. 1 substantially comprises the main body A and the Taptee T screwed in the main body A.

The main body A substantially comprises the tap body 2, the tap handle 1, the tap cartridge 3, the outlet spout 14 and the two concentric tubular legs or tails named inner leg 8 and outer leg 7. The spout 14 and the two concentric legs 7 and 8 connected by the plates 6 are an integral part of the tap body 2 and can be moulded or casted in a single moulding die or casting die.

The inner leg 8 is a hollow tube with plain outer surface except threaded end 9 near its bottom end and top end is connected to the valve seat 4a opened in the tap body 2. Outer diameter of the plain surface is more than outer diameter of the threaded end 9 of the inner leg 8.

The outer leg 7 is a hollow tube having threaded outer surface for engaging the nut N1 for the purpose of fixing and tightening the main body A to surface of washbasin, kitchen sinks, bath tubs or any other surface by screwing in the nut N1. Top end of the outer leg 7 is connected to bottom surface of outer coaxial holes in lower ring of the tap body 2 and opened inside the tap body 2 connecting to the outer valve seat 4b and bottom end is opened for connection to the Taptee T.

The spout 14 is a hollow long tube with one end connected to lateral surface of the tap body 2 having radial opening coaxial to the spout 14 and other end is open with outlet 15 for discharge of mixed water from the tap. The end cap 15 is inserted and fixed in end of the spout 14 as shown in the FIG. 1.

The tap body 2 is a hollow tube with two rings. The upper ring of the tap body 2 is having large inner diameter along with inner thread near top portion for fixing the tap cartridge 3 and one radial hole in its lateral surface with or without inner thread for connecting the spout 14. The tap body 2 acts as housing for the cartridge 3. The lower ring of the tap body 2 is having two concentric holes coaxially aligned to two concentric tubular valve seats 4a and 4b respectively. The inner valve seat 4a is coaxially extruded to connect to top end of the inner leg 8 via inner hole in the lower ring of the tap body 2 and the outer valve seat 4b is coaxial to the tubular outer leg 7 and extruded to touch upper surface of the lower ring of the tap body 2. The outer leg 7 is opened in the outer valve seat 4b. The lower ring also acts as a base for the main body A and along with the outer leg 7 is used for fixing the tap to the supporting surface of wash stand or bath stand or kitchen sink by using a nut N1. Inner surfaces of these valve seats 4a and 4b are connected with inner surfaces of the inner leg 8 and the outer leg 7 respectively allowing water to enter in two concentric ports, inner port 3h and outer port 3g, in the bottom ceramic disc K2 of the cartridge 3 respectively. The outlet tubular spout 14 coaxial with the radial hole in the tap body 2 allowing mixed water to enter in the spout 14 before delivery through an outlet 15 in the spout 14 is connected to lateral surface of the body 2.

The inner leg 8 is concentric and inside the outer leg 7. The inner leg 8 and the outer leg 7 are connected to each other by four or three connecting plates 6 in radial direction. This arrangement of the tap body 2, the inner leg 8, the outer leg 7, the connecting plates 6 and the spout 14 is thought of, invented and developed to make it convenient to manufacture these parts of the main body A from probably a single mould die by moulding process or a single cast die by casting process using material like plastic, metal, glass or ceramic raw materials etc. in addition to its simple connection to surface of kitchen sink, washbasin, bathtubs etc. and economical in cost and easy to install and maintain. In addition the Taptee T is innovated for ease of connection of the main body A to hot and cold water supply lines separately. The tap body 2 can be made of metals or plastic or PVC or any other suitable solid material. These are innovative things which can not be found in the existing prior art water mixer taps.

There is one end cap 16 fixed at top end of the spout 14 so that mixed water should not pass through this end and discharge only through an opening/outlet 15 in the spout 14.

The mono block ceramic discs tap cartridge 3 is shown in the FIG. 20. It is having the brass metal body 3a. It is not described in details, in that it is to be considered known and described in the field and can be seen in search engine like google.com by simply writing ‘single/mono block ceramic disc cartridge’ in search box and clicking on search button. Only difference in the mono block disc cartridge 3 with the prior art is it has two concentric ports, inner port 3h and outer port 3g, in the fixed bottom ceramic disc K2 as shown in the FIGS. 20(c) and 20(d) and two concentric retaining washers or O-ring Ra and Rb. The brass cartridge 3 is housed and fixed inside the tap body 2 by screwing it using threads 3i available in the brass type ceramic disc cartridge as shown in the FIG. 20 and rotatably connected to a tap handle 1 by a screw. This tap cartridge 3 can be PVC/plastic ceramic discs cartridge and can be housed and fixed inside the tap body 2 using a pull out nut. The type of cartridge can be any type available in the market with only main difference is concentric two ports in the lower fixed ceramic disc/washer.

The two concentric retaining washers or O-rings Ra and Rb are fixed in the cartridge 3 and touches the inner valve seat 4a and the outer valve seat 4b respectively and acts as seal between the inner valve seat 4a and the outer valve seat 4b. These two washers or O-rings Ra and Rb stop any water leakage from one leg 7 to other leg 8 towards their top end edge and allow mixed water to outlet 15 when two concentric ports 3h and 3g are open due to rotation of the tap handle 1.

A securing washer W1 and a back nut N1 inserted in the outer leg 7 below base of the tap body 2 is to secure the main body A of the tap to supporting surface of a wash-stand like washbasin, kitchen sinks or bath tubs etc.

The main body A, attachable to the baths, kitchen sinks, washbasin etc., includes the tap body 2, the two concentric legs or tails, the inner leg or tail 8 and another the outer leg or tail 7, connected to each other near their top end by three or four rectangular plates 6 in radial direction or any other means, connected at bottom side of the tap body 2 and the spout 14 at the circumferential side. The main body A further includes mixing chamber 20 for mixing hot and cold water before passing the mixed water to outside of the tap via the spout 14 and then by the outlet 15. The amount of water discharged, and the hot and the cold water proportions of the water discharged, are both controlled by the tap handle 1 rotatably attached to the spindle 3f of the tap cartridge 3. The tap cartridge 3 is housed and fitted in the tap body 2 and having concentric ports/holes in the bottom ceramic discs K2. The ceramic discs tap cartridge 3 is illustrated in the FIG. 20. A hollow disc Z1 and a washer W2 are inserted in the threaded end 9 of the inner leg 8 and stopped near round unthreaded outer surface of the leg 8. The inner leg 8 and the first leg 12 of the outer leg 7 are connected to the Taptee T. The two concentric legs 8 and 7 are inserted in the Taptee T such that the threaded end 9 of the inner leg 8 enters into a hole in the disc seat 9t and the female threaded end 1t screwed in the first leg 12 of the outer leg 7. The nut N3 is tighten to lock the Taptee T. The nut N2 is tighten in the threaded end 9 of the inner leg 8. The tightening of the nut N2 is done so that the washer W2 tightly touches the disc seat 9t in such a way that there should not be any water leakage through the disc seat 9t in the outer leg 7.

The tubular first leg 2t and the tubular second leg 4t of the taptee T are for connection to hot water and cold water lines respectively. These legs 2t and 4t can be connected to hot and cold water lines separately either by female ends hose connector or to elbow or to tee joint or to any other pipe fittings as per requirement. The hose connectors used for connection may or may not be steel armoured. The hose connectors required in the prior art water mixer taps are steel armoured with one end is threaded male and other end is threaded female socket which are costlier and difficult to connect and remove.

The hot water enter the tap (FMT) through the inlet 8t of the first leg 2t and then to an inlet 10 of the inner leg 8 and then the outlet 11 in the inner leg 8 and then inner port 3h in the cartridge 3. The cold water enter the tap (FMT) through the inlet 3t of the second leg 4t and then to an inlet 13 in the first leg 12 of the outer leg 7 and then to an out let 5 of the outer leg 7 and then enter into the outer port 3g in the cartridge 3. If the tap handle 1 is turned manually by user then the hot and cold water further flowed to a mixing chamber 20 before entering in the spout 14 and discharged through the outlet 15. When tap handle 1 rotates, upper ceramic disc (moving) K1 in the cartridge 3 also rotates and the two concentric ports/holes 3h and 3g in the lower disc K2 opened and allow the hot and cold water to flow out of the cartridge 3 and mixed in the mixing chamber 20 and pass through the spout 14 and then the outlet 15. Hot water and cold water lines connections can be interchanged.

The amount and proportion of hot and cold water is controlled by rotation of the tap handle 1. When the tap handle 1 is turned in opposite direction then the water shuts off.

In this manner the tap handle 1 can be operated manually by a user, to allow delivery of the water and at the same time mixing of hot water and cold water.

In this embodiment in place of ceramic discs cartridge 3 other types of tap cartridges can also be used having concentric rubber washer or any other type of washers made of any other materials.

The spout 14 can be separately manufactured with additional features like inner thread socket near end of the tap body and screwed/connected to additional features like threaded header in lateral surface with hole in the tap body 2. This is not disclosed but any person having common sense or knowledge can make it.

The spout 14 may not be integral part of the tap body 2 but can be received by making inner thread in the radial hole in the lateral surface of the tap body 2 coaxial to the tubular outlet spout 14 having threaded spigot with lower diameter than outer diameter of the spout 14 in some other embodiments which are not disclosed in this present invention.

This design makes the Fluid Mixer Taps (FMT) cost effective, easy to install and easy to maintain, robust in construction and ease of operation.

### B. Second Embodiment

FIG. 2 describes the Second Embodiment of the present invention Fluid Mixer Taps (FMT). Partly cross sectional and partly perspective view of the second embodiment of the present invention is shown in FIG. 2.

The fluid mixer tap illustrated in FIG. 2 mainly comprises the main body B and the Toupler C screwed in the main body B.

The main body B of the second embodiment is same as that of the main body A of the first embodiment with a little difference in the outer leg 7 and the spout 14. The outer leg 7′ of the main body B is having the first leg 12 and the second leg 17. This second leg 17 is not a part of the outer leg 7 in the first embodiment of the Fluid Mixer Taps. The spout 14′ of the main body B is different from the spout 14. In this embodiment no end cap 16, securing washer W1 and back nut N1 are required as they are there in the first embodiment.

The inner leg 8 in this second embodiment is same as that in the first embodiment of this invention Fluid Mixer Tap (FMT).

The outer leg 7′ in this second embodiment is same as that in the first embodiment of this invention Fluid Mixer Tap (FMT) with an additional second leg 17. The outer leg 7′ is a hollow tube having threaded first leg 12 near bottom end and threaded tubular leg 17 in radial direction for connection to cold water supply lines and upper end is connected to bottom of the lower ring of the tap body 2 similar to as in the first embodiment. The first leg 12 is for engaging the female threaded end 1c of the Toupling C for the purpose of fixing and tightening the main body B to any suitable pipe fittings i.e. elbow or tee joints etc. of hot water supply line above washbasin, kitchen sinks, bath tubs etc. or in bathroom, washroom, industries etc. The second leg 17 is for connecting pipe fittings i.e. elbow or tee joints etc. or female ends hose connector of hot water supply line above washbasin, kitchen sinks, bath tubs etc. or in bathroom, washroom, industries etc. There is one hexagonal protrude 18 in the second leg 17 for assisting in tightening pipe fitting or female connector of a hose pipe.

The spout 14′ is a hollow long tube with one end connected to the lateral surface of the tap body 2 having radial opening coaxial to the spout 14′ and other end is open with the outlet 15′ for discharge of mixed water from the tap as shown in the FIG. 2.

A hollow disc Z1 and a washer W2 are inserted in the threaded end 9 of the inner leg 8 and stopped near round unthreaded outer surface of the leg 8. The inner leg 8 and the first leg 12 of the outer leg 7′ are connected to the Toupling C by screwing in the female threaded end 1c. The two concentric legs 8 and 7′ are inserted in the Toupling C such that the threaded end 9 of the inner leg 8 enters into a hole in the disc seat 4c and the female threaded end 1c screwed in the first leg 12 of the outer leg 7′. The nut N3 is tighten to lock the Toupling C. A nut N2 is tighten in the threaded end 9 of the inner leg 8. The tightening of the nut N2 is done so that the washer W2 tightly touches the disc seat 4c in such a way that there should not be any water leakage through the disc seat 4c into the outer leg 7′. The tubular first leg 2c of the Toupling C is for connection to hot water line and the second leg 17 of the outer leg 7′ is for connection to the cold water line.

The hot water enter the tap through the inlet 3c of the first leg 2c and then to an inlet 10 of the inner leg 8 and then the outlet 11 in the inner leg 8 and then inner port 3h in the cartridge 3. The cold water enter the tap through the inlet 19 of the second leg 17 and then to an inlet 13′ in the outer leg 7′ and then to an out let 5 of the outer leg 7′ and then enter into the outer port 3g in the cartridge. If the tap handle is turned manually by user then the hot and cold water further flow in to a mixing chamber 20 before entering in the spout 14′ and discharged through the outlet 15′. When tap handle 1 rotates, upper ceramic disc (moving) K1 in the cartridge 3 also rotates and the two concentric ports/holes 3h and 3g in the lower disc K2 opened and allow the hot and cold water flow out of the cartridge 3 to be mixed in a mixing chamber 20 and pass through the spout 14′. The hot water and cold water lines connections can be interchanged.

The first leg 12 of the main body B is attachable to the Toupling C, in the wall above washbasin, kitchen sinks, bath tabs or in washroom, bathroom or toilet etc. The second leg 17 of the main body B is attachable to pipe fittings, like elbow or tee joint or any other pipe fittings of hot water supply lines either directly or through the female ends hose pipe, in the wall above washbasin, kitchen sinks, bath tubs or in washroom, bathroom or toilet, industries etc. The fluid mixer tap in this embodiment can also be fitted in cistern used in toilet for mixed water supply. The second embodiment may not be attachable to kitchen sinks, washbasin or bath tubs directly but can be fitted in the wall above the kitchen sink, washbasin, bathtubs etc.

The amount and proportion of hot and cold water is controlled by the rotation of the tap handle 1. When the tap handle 1 is turned in opposite direction than the water shuts off.

In this embodiment in place of ceramic discs cartridge 3 other types of tap cartridges can also be used having concentric rubber washer or any other type of washers made of any other materials.

The spout 14′ can be separately manufactured with additional features like inner thread socket near end of the tap body and screwed/connected to additional features like threaded header in lateral surface in the tap body 2. This is not disclosed but any person having common sense or knowledge can make it.

In this manner the tap handle 1 can be operated manually by a user, to allow delivery of the water and at the same time mixing of hot water and cold water.

The spout 14′ may not be integral part of the tap body 2 but can be received by making inner thread in the radial hole in the lateral surface of the tap body 2 coaxial to the tubular outlet spout 14′ having threaded spigot with lower diameter than outer diameter of the spout 14′ in some other embodiments which are not disclosed in this present invention.

This design makes the Fluid Mixer Taps (FMT) cost effective, easy to install and easy to maintain, robust in construction and easy in operation.

### C. Third Embodiment

FIG. 3 describes the Third Embodiment of the present invention Fluid Mixer Tap (FMT). Partly cross sectional and partly perspective view of the Third Embodiment of the present invention FMT is shown in FIG. 3.

FIG. 4 describes the main body D of the third embodiment of the present invention Fluid Mixer Tap (FMT). Partly cross sectional and partly perspective view of the main body D is shown in FIG. 3 and FIG. 4.

The Fluid Mixer Tap (FMT) illustrated in FIG. 3 substantially comprises the main body D and the Taptee T screwed in the main body D.

The main body D substantially comprises two tap bodies 2ax and 2ay, two tap cartridges 3ax and 3ay, two tap handles 1ax and 1ay, a header 13a, an interlocking mechanism, an outlet spout 12a and two concentric tubular legs inner leg 15a and outer leg 14a. The header 13a, the two concentric legs 15a and 14a are integral parts of the tap bodies 2ax and 2ay and can be moulded or casted in a single moulding die or casting die respectively making it cost effective and easy to manufacture commercially.

The main body D of the third embodiment is same as that of the main body A of the first embodiment with a difference in connectivity of concentric legs 14a and 15a with two valve seats 4ax and 4ay and two tap bodies 2ax and 2ay respectively, difference in ports in the cartridges 3ax and 3ay, difference in connectivity of the spout 12a with the header 13a and availability of the interlocking mechanism for hot water and cold water. Except the interlocking mechanism and two tap bodies and spindle-washer cartridge used in this embodiment there is not much difference in the first embodiment and the third embodiment of the present invention if think deeply.

The tap bodies 2ax and 2ay are hollow tubes extended at bottom end connected to the outer leg 14a, the inner leg 15a and the header 13a and the top end is having inner threads for fixing cartridges 3ax and 3ay inside the tap body 2ax and 2ay respectively as shown in the FIG. 3. The two valve seat tubes 4axt and 4ayt are an integral part of the tap bodies 2ax and 2ay respectively and also extruded to the outer leg 14a and the inner leg 15a respectively at bottom end and connected to the valve seats 4ax and 4ay respectively at top end. The upper part of the tap bodies 2ax and 2ay are having large inner diameter along with inner threads near top end portion for fixing the tap cartridges 3ax and 3ay respectively. Their lower portion is curved and designed such that the valve seat tubes 4axt and 4ayt protrude inside them. The tap bodies 2ax and 2ay extruded to the inner leg 15a and the outer leg 14a respectively, extruded to the header 13a and also they are connected to each other as shown in the FIG. 3 and FIG. 4. There is one outlet opening 6ax and 6ay towards the header 13a in the tap bodies 2ax and 2ay respectively for allowing water to enter in the header 13a. The tap bodies 2ax and 2ay act as housing for the cartridges 3ax and 3ay respectively. The hollow valve seat tube 4axt at its bottom end protrudes in the tap body 2ax is also connected to upper end of the outer leg 14a for allowing water to enter in the valve seat 4ax via the outer leg 14a. The hollow valve seat tube 4ayt at its bottom end protrudes in the tap body 2ay is also connected to upper end of the inner leg 15a for allowing water to enter in the valve seat 4ay via the inner leg 15a. A protrude 27a in the outer leg 14a acts as a base for the main body D and along with the outer leg 14a it is used for fixing on supporting surface of a wash stand or bath stand or kitchen sink or any other such surface by using and tightening a nut N1. Inner surfaces of these valve seat tubes 4axt and 4ayt are matching with inner surfaces of the inner leg 15a and the outer leg 14a respectively and the inner surfaces of the valve seats 4ax and 4ay respectively and allows water to enter in the mixer chamber 7a through the interlocking mechanism through the outlet 6ax of the tap body 2ax and the outlet 6ay of the tap body 2ay when tap handles 1ax and 1ay are turned for lifting up the cartridges 3ax and 3ay respectively allowing cold and hot water to enter in the interlocking mechanism respectively. The outlet tubular spout 12a bottom end is coaxial with an opening in the header 13a and screwed in the threaded end 21a in top end of the header 13a for allowing mixed water to enter in the spout 12a before delivery through an aerator a1 fitted in outlet in the spout 15a.

The inner leg 15a is a hollow tube with plain outer surface except threaded end 17a near its bottom end and bent near its top end extruded to connect to the valve seat tube 4ayt, the tap bodies 2ax and 2ay and to top end of the outer leg 14a. The outer diameter of the plain surface of the inner leg 15a is more than the outer diameter of the threaded end 17a of the inner leg 15a.

The outer leg 14a is a hollow tube having threaded outer surface for engaging the nut N1 for the purpose of fixing and tightening the main body D near the protrude 27a to the surface of washbasin, kitchen sinks, bath tubs or any other such surface by screwing and tightening the nut N1. The top end of the outer leg 14a is extruded to the tap bodies 2ax and 2ay, the valve seat 4axt and top end of the inner leg 15a.

The spout 12a is a hollow long bent tube with one bottom socket end having inner thread and top end is connected to the aerator a1. The spout 12a with aerator a1 is same as any other similar spout available in the market. The socket bottom end is connected to the header 13a by screwing in the threaded end 21a of the header 13a.

The inner leg 15a is concentric to the outer leg 14a for most portion of their length. The inner leg 15a is inside the outer leg 14a. Top end of both the legs 15a and 14a are bent and extended to connect to the valve seat 4ay and 4ax via the valve seat tubes 4ayt and 4axt respectively as shown in the FIG. 3. The protrude 27a in the outer surface of the outer leg 14a is used as base for the main body D for fitting on surface of kitchen sinks, washbasin, bathtubs etc. by the securing washer W1 and the nut N1. The inner leg 15a and the outer leg 14a are connected to each other and to the tap bodies 2ax and 2ay in such a way that they allow independently flow of cold and hot water to be mixed in the mixing chamber 7a when the tap handle 1ay and then 1ax are turned. This arrangement of the tap bodies 2ax and 2ay, the inner leg 15a, the outer leg 14a and the header 13a is thought of, invented and developed to make it convenient to manufacture these parts of the main body D from probably a single mould die by moulding process or a single cast die by casting process using material like plastic, metal, glass or ceramic raw materials etc. In addition the taptee T is innovated for ease of connection of the main body D to hot and cold water supply lines separately. The tap bodies 2ax and 2ay can be made of metals or plastic or PVC or any other suitable solid material. These are innovative things which can not be found in the existing prior art water mixer taps.

The spindle-washer tap cartridge or ceramic discs tap cartridge 3ax and 3ay are not described in details, in that it is to be considered known and described in the field and can be seen in search engine like google.com by simply writing ‘spindle-washer tap cartridge or ceramic disc tap cartridge’ in search box and clicking on search button. Two washers W3 each are connected to the cartridges 3ax and 3ay sit on valve seats 4ax and 4ay of the tap bodies 2ax and 2ay respectively when the tap is shuts off.

The tap bodies 2ax and 2ay of the main body D, attachable to the baths, kitchen sinks, washbasin etc., includes the two concentric legs or tails, the inner leg or tail 15a and the outer leg or tail 14a, the interlocking mechanism and the header 13a. The two concentric legs 14a and 15a are connected to each other at their top ends as well as to the tap bodies 2ax and 2ay as shown in the FIG. 3. The tap bodies 2ax and 2ay further include mixing chamber 7a in the header 13a for mixing hot and cold water before passing the mixed water to outside of the tap via the spout 13a, a partition wall 20a between outlets 6ax and 6ay for allowing hot and cold water in the mixing chamber 7a through the interlocking mechanism. The amount of water discharged, and the hot and the cold water proportions of the water discharged, are both controlled by two tap handles 1ax and 1ay rotatably attached to the spindle of the tap cartridges 3ax and the 3ay respectively. The tap cartridges 3ax and 3ay are housed and fitted in the tap bodies 2ax and 2ay respectively. The inner leg 15a and the first leg 18a of the outer leg 14a are connected to the Taptee T. The hollow disc Z1 and the washer W2 are inserted in the threaded end 17a of the inner leg 15a and stopped near round unthreaded outer surface of the leg 15a. The two concentric legs 15a and 14a are inserted in the Taptee T i.e. the Taptee T is screwed in the main body D such that the threaded end 17a of the inner leg 15a enters into a hole in the disc seat 9t and the female threaded end It screwed in the first leg 18a of the outer leg 14a. The nut N3 is tighten to lock the Taptee T. A nut N2 is tighten in the threaded end 17a of the inner leg 15a. The tightening of the nut N2 is done so that the washer W2 tightly touches the disc seat 9t in such a way that there should not be any water leakage through the disc seat 9t in the outer leg 14a.

The tubular first leg 2t and the tubular second leg 4t of the taptee T are for connection to cold water and hot water lines respectively as described in the first embodiment of this invention.

The interlocking mechanism comprises the header 13a extruded at its bottom to the tap bodies 2ax and 2ay, the header disc 8a, the stopper M1, the header disc seat body L1, the partition wall 20a and grooves 9a, 10a and 11a in the header 13a . The partition wall 20a separates two tap bodies 2ax and 2ay and is for keeping hot and cold water separately before entering in the mixing chamber 7a through the interlocking mechanism. The header disc 8a with its heavier surface side due to additional weight 8ab is kept towards cold water line and other end towards hot water line. The two cylindrical protrudes 8aa are inserted in the two opposite grooves 11a and two sides of the disc 8ac rotates about an axis of the two protrudes 8aa. The stoppers M1 with its curved surface M1a towards bottom side facing the curved face of the protrudes 8aa are inserted in the two opposite grooves 11a from top and are fixed to allow the disc 8ac to rotate about the protrudes' 8aa axis. The additional weight 8ab is for keeping heavier side in downward direction to ensure touching of opposite upper end to the disc seat L1b. The header disc seat body L1 with the disc seat L1b, facing and touching upper face of the disc 8ac, is inserted in the three grooves one 9a and other two opposite grooves 10a by using the three protrudes L1a. The body L1 is fixed in the header 13a towards hot water line at a location where one side of the disc 8ac touches the seat L1b due to gravitational force due to additional weight 8ab which try to pull this side of the disc in downward direction. The touching of the disc 8ac with the seat L1b does not allow hot water to enter into the mixing chamber 7a until the tap handle 1ay is turned to allow delivery of cold water from the inner leg 15a into outlet 6ay thereby lifting/pushing half portion of the disc 8ac in upward direction causing downward motion for the portion of the disc 8ac in hot water line direction due to rotation of the disc about the protrudes 8aa axis resulting into opening of the disc seat L1b allowing hot water to enter in the mixer chamber 7a if the tap handle 1ax is turned. This interlocking will not allow the hot water to enter in the mixer chamber 7a until the cold water tap handle 1ay is turned there by lifting the washer W3 and allowing cold water to enter in the mixer chamber first. If there is no cold water and only hot water is available in the hot water line then even after opening of valve seat 4ay by turning the tap handle 1ay the disc seat L1b will not open since the disc 8ac will remain touching it there by obstructing flow of hot water in the mixer chamber 7a through the inner opening (L1d) in the body L1 and hence no water will be delivered by the spout 12a through the aerator a1. When the tap handle 1ay turned in one direction cold water enters the interlocking mechanism rotating the disc 8ac making opening in this side of the header as well as on the opposite side of it and when the tap handle 1ax is turned the hot water enters the mixing chamber 7a and then mixed water flows out of the spout 12a through the aerator a1. This interlocking will protect users from scalding injuries and thermal shock. Such interlocking mechanism are not there in prior art.

The connection of the main body D to the Taptee T is same as that in the first embodiment and is not explained here. The first leg 2t is connected to the cold water line and the second leg 4t is connected to the hot water line using either hose pipes or any other suitable pipe fittings.

The cold water enter the tap through the inlet 8t of the first leg 2t and then to an inlet 16a of the inner leg 15a and then the outlet 5ay in the inner leg 15a and then the valve seat 4ay and if the tap handle 1ay is turned manually by user then the washer W3 is lifted up and cold water further flowed to the outlet 6ay, then the cold water push and rotate the disc 8ac thereby allowing cold water to enter in the mixing chamber 7a before entering in the spout 12a. The hot water enter the tap through the inlet 3t of the second leg 4t and then to an inlet 19a in the first leg 18a of the outer leg 14a and then to an out let 5ax of the outer leg 14ax and then enter into the valve seat 4ax in the tap body 2ax and if the tap handle is turned manually by user then the hot water further flowed to outlet 6ax and will enter the mixing chamber 7a only when the disc 8ac is in downward direction allowing flow of hot water to the mixing chamber 7a before entering in the spout 12a and then mixed water discharged through the spout 12a and the aerator a1.

The amount and proportion of hot and cold water is controlled by rotation of the tap handles 1ax and 1ay. When the tap handles 1ax and 1ay are turned in opposite direction then the water shuts off.

In this manner the tap handles 1ax and 1ay can be operated manually by a user, to allow delivery of the water and the mixing of hot water and cold water.

In this embodiment in place of spindle-washer cartridges 3ax and 3ay other types of tap cartridges can also be used.

This design makes the Fluid Mixer Tap or Valve (FMT) cost effective, easy to install, easy to maintain, robust in construction and ease of operation.

### D. Fourth Embodiment

FIG. 5 describes the main body E of the Fourth Embodiment of the present invention Fluid Mixer Tap (FMT). Partly cross sectional and partly perspective view of the main body of the Fourth Embodiment of the present invention is shown in FIG. 5.

The Fluid Mixer Tap (FMT) in the Fourth Embodiment mainly comprises a main body E and the Taptee T. In FIG. 5, only the main body E is shown. The Taptee T is connected to the main body E in the same way as it is to the main body D in the third embodiment.

The main body E of the fourth embodiment is same as that of the main body D of the third embodiment without the interlocking mechanism in the header 13a′ as shown in the FIG. 5. Here the header 13a′ is connected to the tap bodies 2ax and 2ay having threaded upper end for screwing in the spout 12a. In the header 13a′ there are no grooves 9a, 10a, 11a, no header disc 8a, no stopper M1, no header disc body L1 and no partition wall 20a. When both tap handle 1ax and 1ay are open then hot and cold water directly reaches the mixer chamber 7a′ through the outlet 6ax and 6ay.

The connection of the main body E to the Taptee T is same as that in the third embodiment and is not explained here. The first leg 2t is connected to the cold water supply line and the second leg 4t is connected to the hot water supply line using either hose pipes or any other suitable pipe fittings. Here connections are interchangeable.

The cold water enter the tap through the inlet 8t of the first leg 2t and then to an inlet 16a of the inner leg 15a and then the outlet Say in the inner leg 15a and then the valve seat 4ay and if the tap handle 1ay is turned manually by user then the washer W3 lifted up and cold water further flowed to the outlet 6ay after that reaches the mixing chamber 7a′ before entering in the spout 12a. The hot water enter the tap through the inlet 3t of the second leg 4t and then to an inlet 19a in the first leg 18a of the outer leg 14a and then to an out let Sax of the outer leg 14a and then enter into the valve seat 4ax in the tap body 2ax and if the tap handle 1ax is turned manually by user then the cold water further flowed to outlet 6ax and after that enter the mixing chamber 7a′ before entering in the spout 12a and then mixed water discharged through the spout 12a and the aerator a1.

The amount and proportion of hot and cold water is controlled by the rotation of the tap handles 1ax and 1ay. When the tap handles 1ax and 1ay are turned in opposite direction then the water shuts off.

In this manner the tap handles 1ax and 1ay can be operated manually by a user, to allow delivery of the water and the mixing of hot water and cold water.

In this embodiment in place of spindle-washer cartridges 3ax and 3ay other types of tap cartridges can also be used.

This design makes the Fluid Mixer Taps (FMT) cost effective, easy to install and easy to maintain, robust in construction and easy in operation.

### E. Fifth Embodiment

FIG. 6 describes the Fifth Embodiment of the present invention Fluid Mixer Taps (FMT). Partly cross sectional and partly perspective view of the fifth embodiment of the present invention is shown in FIG. 6.

The Fluid Mixer Tap (FMT) illustrated in FIG. 6 mainly comprises the main body F and the Toupling C.

FIG. 7 shows cross sectional and perspective view of the main body F. The main body F of the fifth embodiment is same as that of the main body E of the fourth embodiment with additional leg 24a in its the outer leg 14a′ and instead of the taptee T it is connected to the Toupling C and the spout 12a′ is slightly different from the spout 12a.

The outer leg 14a′ is a hollow tube having threaded first leg 18a near bottom end and threaded tubular second leg 24a in radial direction for connection to hot water supply line and top end is connected to the tap bodies 2ax and 2ay and inner leg 15a. The first leg 18a is for engaging the female threaded end 1c of the toupling C for the purpose of fixing and tightening the main body F to any suitable pipe fittings i.e. elbow or tee joints etc. of cold water supply line above washbasin, kitchen sinks, bath tubs etc. or in bathroom, washroom, industries etc. The second leg 24a is for connecting pipe fittings i.e. elbow or tee joints etc. or female ends hose connector of hot water supply line above washbasin, kitchen sinks, bath tubs etc. or in bathroom, washroom, industries etc. There is one hexagonal protrude 25a in the second leg 24a for assisting in tightening pipe fitting or female connector of hose pipe.

The spout 12a′ is a hollow long bent tube with one bottom socket end having inner thread and other open end connected to the aerator a1. The spout 12a′ with aerator a1 is same as any other similar spout available in the market to be used for the purpose disclosed in this embodiment. The spout 12a′ by its threaded bottom socket end is screwed in the threaded end 21a of the header 13a′.

The first leg 18a of the main body F is attachable to pipe fittings, like elbow or tee joint or any other pipe fittings of cold water supply lines through the Toupling C, in the wall above washbasin, kitchen sinks, bath tabs or in washroom, bathroom or toilet etc. The second leg 24a of the main body F is attachable to pipe fittings, like elbow or tee joint or any other pipe fittings of hot water supply lines either directly or through the female ends hose pipe, in the wall above washbasin, kitchen sinks, bath tabs or in washroom, bathroom or toilet, industries etc. The fluid mixer tap in this embodiment can also be fitted in cistern used in toilet for mixed water supply.

The inner leg 15a and the first leg 18a of the outer leg 14a′ are connected to the Toupling C. A hollow disc Z1 and a washer W2 are inserted in the threaded end 17a of the inner leg 15a and stopped near round unthreaded outer surface of the inner leg 15a. The two concentric legs 15a and 14a′ are inserted in the Toupling C such that the threaded end 17a of the inner leg 15a enters into a hole in the disc seat 4c and the female threaded end 1c screwed in the first leg 18a of the outer leg 14a′. There is one washer W4 inserted between the Toupling C and the second leg 18a before screwing in the Toupling C in the main body F. A nut N2 is tighten in the threaded end 17a of the inner leg 15a. The tightening of the nut N2 is done so that the washer W2 tightly touches the disc seat 4c in such a way that there should not be any water leakage through the disc seat 4c in the outer leg 14a′. The tubular first leg 2c of the Toupling C is for connection to cold water supply line and the second leg 24a of the outer leg 14a′ is for connection to the hot water supply line. Although cold and hot water supply lines are interchangeable.

The cold water enter the tap through the inlet 3c of the first leg 2c and then to the inlet 16a of the inner leg 15a and then the outlet 5ay in the inner leg 15a before entering the valve seat 4ay and if the tap handle 1ay is turned manually by user then the cold water further flowed to the mixing chamber 7a′ through the outlet bay before entering in the spout 12a′. The hot water enter the tap through an inlet 22a of the second leg 24a and then to the inlet 23a in the outer leg 14a′ and then to an out let 5ax of the outer leg 14a′ and enter the valve seat 4ax and if the tap handle 1ax is turned manually by user then the hot water further flowed to the mixing chamber 7a′ through the outlet 6ax before entering in the spout 12a′. Hot and cold water mixed in the mixing chamber 7a′ before entering in the spout 12a′ and then finally discharged through the aerator a1. When both tap handles 1ax 1na 1ay are turned then a mixed water flows out from the outlet 12a′. The hot water and cold water lines connections can be interchanged.

The amount and proportion of hot and cold water is controlled by the rotation of the tap handles 1ax and 1ay. When the tap handles 1ax and 1ay are turned in opposite direction than the water shuts off.

In this manner the tap handles 1ax and 1ay can be operated manually by a user, to allow delivery of the water and the mixing of hot water and cold water.

In this embodiment in place of spindle-washer cartridges 3ax and 3ay other types of tap cartridges can also be used.

This design makes the Fluid Mixer Tap (FMT) cost effective, easy to install and easy to maintain, robust in construction and easy in operation.

### F. Sixth Embodiment

FIG. 8 describes the Sixth Embodiment of the present invention Fluid Mixer Tap (FMT). Partly cross sectional and partly perspective view of the second embodiment of the present invention is shown in FIG. 8.

The fluid mixer tap illustrated in FIG. 8 mainly comprises the main body A′ and the Taptee T.

The main body A′ of the sixth embodiment is same as that of the main body A of the first embodiment except the two tubes/openings 14b and 15b in the spout 13b connected to two radial openings in lateral surface of the tap body 2b and single port tap cartridge 3b.

The main body A′ substantially comprises the tap cartridge 3b housed in the tap body 2b connected to the outlet spout 13b and the two concentric tubular legs or tails named inner leg 6b and outer leg 7b. The spout 13b and the two concentric legs 6b and 7b connected by the plates 24b are an integral part of the tap body 2b and can be moulded or casted in a single moulding die or casting die.

The inner leg 6b is a hollow tube with plain outer surface except threaded end 10b near its bottom end and top end is connected to the valve seat 4b and the connecting plate 24b and opened in the tap body 2b. Outer diameter of the plain surface is more than outer diameter of the threaded end 10b of the inner leg 6b.

The outer leg 7b is a hollow tube having threaded outer surface for engaging the nut N1 for the purpose of fixing and tightening the main body A′ to surface of washbasin, kitchen sinks, bath tubs or any other surface by screwing in the nut N1. Top end of the outer leg 7b is connected near bottom surface of the tap body 2b and the connecting plate 24b and opened in the lower tube 15b of the spout 13b and bottom end is opened for connection to the Taptee T.

The spout 13b is a hollow long tube having two tubes 14b and 15b with one end connected to two radial openings in lateral surface of the tap body 2b aligned to the upper tube hole 14b and lower tube hole 15b respectively and other end is opened with outlet 16b for discharge of mixed water from the Fluid Mixer Tap (FMT). The end cap 17b is inserted and fixed in the end of the spout 13b as shown in the FIG. 8.

The tap body 2b is a hollow tube with two rings. The upper ring of the tap body 2b is having large inner diameter in upper about half portion along with inner thread near top portion and one radial hole in its lateral surface for connecting upper tube or opening 14b in the spout 13b. The bottom lower about half portion is having the valve seat 4b coaxially connected to the inner leg 6b, an inner hollow tubular area cut below the connecting plate 24b extruded and coaxial with the outer leg 7b and having one radial hole in lateral surface for connecting lower tube or opening 15b in the spout 13b to the outer leg 7b for flow of fluids. The tap body 2b acts as housing for the cartridge 3b. The lower ring of the tap body 2b is having one coaxial tubular cut extruded and connected and aligned to the outer leg 7b. The inner valve seat 4b is aligned, connected and coaxial to the tubular inner leg 6b. The lower ring also acts as a base for the main body A′ and along with the outer leg 7b is used for fixing it to supporting surface of a wash stand or bath stand or kitchen sink etc. by using a nut N1. Inner surfaces of the valve seats 4a is matching with inner surface of the inner leg 6b and allows water to enter below the washer W3. The inside surface of the inner tube in the lower half portion and lower ring of the tap body is matching with inner surface of the outer leg 7b. Two tubular holes 14b and 15b in the spout 13b are connected to radial hole in the upper portion and lower portion of the upper ring of the tap body 2b for allowing hot and cold water separately before delivery to an outlet 16b in the spout 13b.

The inner leg 6b is concentric and inside the outer leg 7b. The inner leg 6b is supported and connected to the tap body 2b by inner end of the hollow connecting plate 24b by its top end and outer circumferential end of the connecting plate 24b is connected to the lower portion of the tap body 2b as per FIG. 8. The valve seat 4b is coaxial and its inner surface is aligned to inner surface of the inner leg 6b. Top end of the outer leg 7b is supported and connected to bottom surface of the lower ring of the tap body 2b and coaxial to the inner hollow tubular cut in the lower portion of the upper ring of the tap body 2b as per FIG. 8. This arrangement of the tap body 2b, the inner leg 6b, the outer leg 7b, the connecting plate 24b and the spout 13b is thought of and developed to make it convenient to manufacture these parts of the main body A′ from probably a single mould die by moulding process or a single cast die by casting process using material like plastic, metal, glass or ceramic raw materials etc. In addition the taptee T is innovated for ease of connection of the main body A′ to hot and cold water supply lines separately. The tap body 2b can be made of metals or plastic or PVC or any other suitable solid material. These are innovative things which can not be found in the existing prior art water mixer taps.

There is one end cap 17b fixed at top end of the spout 13b so that mixed water should not pass through this end and discharge only through an opening/outlet 16b in the spout 13b.

The spindle-washer tap cartridge or ceramic discs tap cartridge 3b is not described in details, in that it is to be considered known and described in the field and can be seen in search engine like google.com by simply writing ‘spindle-washer tap cartridge or ceramic disc tap cartridge’ in search box and clicking on search button. One washer W3 is connected to the cartridge 3b sit on valve seats 4b of the tap body 2b.

In the outer leg 7b below base of the tap body 2b, a securing washer W1 and a back nut N1 acts to secure the main body A′ of the tap to a supporting surface of a wash-stand like washbasin, kitchen sinks or bath tubs etc.

The main body A′, attachable to the baths, kitchen sinks, washbasin etc., includes the tap body 2, the two concentric legs or tails, one inner leg or tail 6b whose top end connected to the tap body 2b by the circular hollow connecting plate 24b and another outer leg or tail 7b connected to bottom ring of the tap body 2b and the spout 13b connected at the lateral surface of the tap body 2b. The spout 13b further includes mixing chamber/outlet 16b for mixing the hot and the cold water before passing the mixed water to outside of the tap via the outlet 16b. The amount of hot water discharged is controlled by the tap handle 1b rotatably attached to spindle of the tap cartridge 3b. The tap cartridge 3b is housed and fitted in the tap body 2b having the washer W3 fixed in the bottom. The amount of cold water is controlled by a separate tap (not shown in the FIG. 8) connected to the second leg 4t using hose pipe or any other suitable pipe fittings. A hollow disc Z1 and a washer W2 are inserted in the threaded end 10b of the inner leg 6b and stopped near round unthreaded outer surface of the leg 6b. The inner leg 6b and the first leg 12b of the outer leg 7b are connected to the Taptee T. The two concentric legs are inserted in the Taptee T such that the threaded end 10b of the inner leg 6b enters into a hole in the disc seat 9t and the female threaded end 1t screwed in the first leg 12b of the outer leg 7b. The nut N3 is tighten to lock the Taptee T. The nut N2 is tighten in the threaded end 10b of the inner leg 6b. The tightening of the nut N2 is done so that the washer W2 tightly touches the disc seat 9t in such a way that there should not be any water leakage through the disc seat 9t.

The tubular first leg 2t and the tubular second leg 4t of the taptee T are for connection to hot water and cold water lines respectively. These legs 2t and 4t can be connected to hot and cold water lines separately either by female ends hose connector or elbow or tee joint or any other pipe fittings as per requirement. The second leg 4t is connected to a water tap by a female hose connector or any other suitable pipe fittings. The water tap is connected to the cold water line. The hose connectors used for connection may or may not be steel armoured. The hose connectors required in the existing water mixer taps are steel armoured with one end is threaded male and other end is threaded female socket which are costlier.

The hot water enter the tap through the inlet 8t of the first leg 2t and then to an inlet 9b of the inner leg 6b and then the outlet 5b in the inner leg 6b and then the washer W3 in the cartridge 3b and if the tap handle 1b is turned manually by user then the hot water further flowed to a mixing chamber/outlet 16b after the spout 13b. When tap handle 1b rotates, the washer W3 lifted up and then open the valve seat 4b and allow hot water out of the tap body 2b to be mixed in the mixing chamber 16b after passing through the upper chamber 14b. The cold water enter the tap body 2b through the inlet 3t of the second leg 4t and then to an inlet 11b in the first leg 12b of the outer leg 7b and then to an out let 8b of the outer leg 7b and then enter into the lower chamber 15b in the spout 13b and then the hot water further flowed to a mixing chamber 16b and then discharged. The flow of hot water is controlled by the external tap connected to the second leg 4t. The hot water and cold water lines connections can be interchanged. In some uses there may be one type of water or one source of water feeding both inlets.

The amount and proportion of hot and cold water is controlled by the rotation of the tap handle 1b and opening/closing of the external tap handle. When the tap handle 1b is turned in opposite direction than the hot water shuts off.

In this embodiment in place of spindle-washer cartridges 3b other types of tap cartridges can also be used.

The spout 13b can be separately manufactured with additional features like inner thread socket near end of the tap body 2b and screwed/connected to additional features like threaded header in lateral surface in the tap body 2b. This is not disclosed but any person having common sense or knowledge can make it.

The spout 13b may not be integral part of the tap body 2b but can be received by making inner thread in the radial holes in the lateral surface of the tap body 2b coaxial to the tubular outlet spout 13b having threaded spigot with lower diameter than outer diameter of the spout 13b in some other embodiments which are not disclosed in this present invention. The two chambers 14b and 15b can be concentric and the holes in radial direction in the tap body 2b may be concentric in some other embodiments not disclosed in this present invention.

This design makes the Fluid Mixer Tap (FMT) cost effective, easy to install and easy to maintain, robust in construction and easy in operation.

### G. Seventh Embodiment

FIG. 10 describes the Seventh Embodiment of the present invention Fluid Mixer Tap (FMT). Partly cross sectional and partly perspective view of the second embodiment of the present invention is shown in FIG. 10.

The fluid mixer tap illustrated in FIG. 8 mainly comprises a main body B′ and the Toupling C.

The main body B′ of the seventh embodiment is same as that of the main body A′ of the sixth embodiment with a little difference in the outer leg 7b and the spout 13b. An outer leg 7b′ of the main body B′ is having the first leg 12b and the second leg 23b. This second leg 23b is not a part of the outer leg 7b in the sixth embodiment of the present invention Fluid Mixer Taps. A spout 13b′ of the main body B′ is different from the spout 13b of the main body A′ in the sixth embodiment of the present invention FMT. In this embodiment no end cap 17b, securing washer W1 and back nut N1 are required as they are there in the sixth embodiment.

The outer leg 7b′ is a hollow tube having threaded first leg 12b near bottom end and threaded tubular second leg 23b in radial direction for connection to cold and hot water lines respectively. The first leg 12b is for engaging the female threaded end 1c of the toupling C for the purpose of fixing and tightening the main body B′ to any suitable pipe fittings i.e. elbow or tee joints etc. of cold water supply line above washbasin, kitchen sinks, bath tubs etc. or in bathroom, washroom, industries etc. through the toupling C. The second leg 23b is for connecting pipe fittings i.e. elbow or tee joints etc. or female ends hose connector of hot water supply line above washbasin, kitchen sinks, bath tubs etc. or in bathroom, washroom, industries etc. There is one hexagonal protrude 21b in the second leg 23b for assisting in tightening pipe fitting or female connector of hose pipe. Also there is one hexagonal protrude 19b in the first leg 12b for assisting in tightening the toupling C.

The spout 13b′ is a hollow long tube with the two chambers, upper chamber 14b and lower chamber 15b is same as that in the sixth embodiment with difference in its outlet opening. The outlet 18b is aligned with the spout 13b′ axis and directly allow mixed hot and cold water delivery. Here there is no end cap 17b similar to one in the sixth embodiment.

The first leg 12b of the main body B′ is attachable to female end 1c of the toupling and its male end 2c is attachable to pipe fittings, like elbow or tee joint or any other pipe fittings of cold water supply, in the wall above washbasin, kitchen sinks, bath tubs or in washroom, bathroom or toilet etc. The second leg 23b of the main body B′ is attachable to pipe fittings, like elbow or tee joint or any other pipe fittings of hot water supply lines either directly or through the female ends hose pipe, in the wall above washbasin, kitchen sinks, bath tabs or in washroom, bathroom or toilet, industries etc. through an external normal water tap not shown in the FIG. 10. The fluid mixer tap in this embodiment can be fitted in cistern used in toilet for mixed water supply. This seventh embodiment may not be attachable to kitchen sinks, washbasin or bath tubs directly.

The inner leg 6b and the first leg 12b of the outer leg 7b′ are connected to the Toupling C. A hollow disc Z1 and a washer W2 are inserted in the threaded end 10b of the inner leg 6b and stopped near round unthreaded outer surface of the inner leg 7b′. The two concentric legs 6b and 7b′ are inserted in the Toupling C such that the threaded end 10b of the inner leg 6b enters into a hole in the disc seat 4c and the female threaded end 1c screwed in the first leg 12b of the outer leg 7b′. The washer W4 is placed between the toupling C and a hexagonal protrude 19b before screwing in the toupling C in the main body B′. A nut N2 is tighten in the threaded end 10b of the inner leg 6b. The tightening of the nut N2 is done so that the washer W2 tightly touches the disc seat 4c in such a way that there should not be any water leakage through the disc seat 4c in the outer leg 7b′. The tubular first leg 2c of the toupling C is for connection to cold water supply line and the second leg 23b of the outer leg 7b′ is for connection to the hot water supply line. Although cold and hot water supply lines are interchangeable. In some uses there may be one type of water or one source of water feeding both inlets 2c and 23b.

The cold water enter the tap through the inlet 3c of the first leg 2c and then to an inlet 9b of the inner leg 6b and then the outlet 5b in the inner leg 6b and then the washer W3 and if the tap handle 1b is turned manually by user then the hot water further flowed to a mixing chamber/outlet 18b after entering in the upper chamber 14b of the spout 13b′. When the tap handle 1b rotates, the washer W3 lifted up and the valve seat 4b gets opened and allow the cold water flow out of the tap body 2b to be mixed in the mixing chamber 18b and pass through the spout 13b′. The hot water enter the tap through the inlet 22b of the second leg 23b and then to an inlet 20b in the outer leg 7b′ and then to an out let 8b of the outer leg 7b′ and then directly enter into the lower chamber 15b in the spout 13b′. The second leg 23b is connected to a separate tap (which is not shown in the FIG. 10) by females end hose connector and if the tap handle is turned manually by user then the hot water flow is controlled by this external tap. The hot water and cold water lines connections can be interchanged.

The amount and proportion of hot and cold water is controlled by the rotation of the tap handle 1b and the tap handle of the external tap respectively. When the tap handle 1b is turned in opposite direction than the cold water shuts off.

In this embodiment in place of spindle-washer cartridges 3b other types of tap cartridges can also be used.

The spout 13b′ can be separately manufactured with additional features like inner thread socket near end of the tap body 2b and screwed/connected to additional features like threaded header in lateral surface in the tap body 2b. This is not disclosed but any person having common sense or knowledge can make it.

The spout 13b′ may not be integral part of the tap body 2b but can be received by making inner thread in the radial holes in the lateral surface of the tap body 2b coaxial to the tubular outlet spout 13b′ having threaded spigot with lower diameter than outer diameter of the spout 13b′ in some other embodiments which are not disclosed in this present invention. The two chambers 14b and 15b can be concentric and the holes in radial direction in the tap body 2b may be concentric in some other embodiments not disclosed in this present invention.

This design makes the Fluid Mixer Taps (FMT) cost effective, easy to install and easy to maintain, robust in construction and easy in operation.

### H. Eighth Embodiment

FIG. 11 describes the Eighth Embodiment of the present invention Fluid Mixer Tap (FMT). Partly cross sectional and partly perspective view of the eighth embodiment of the present invention is shown in FIG. 11.

The fluid mixer tap illustrated in FIG. 11 mainly comprises the main body G and the Toupling C.

The main body G of the eighth embodiment is same as that of the main body F of the fifth embodiment with the two tap bodies 2dx and 2dy on opposite end, the header 9d is attachable to pipe fittings like coupler, elbow or tee etc.

The main body G substantially comprises two tap bodies 2dx and 2dy, two tap cartridges 3dx and 3dy, two tap handle 1dx and 1dy, a header 9d and two concentric tubular legs, inner leg 13d and outer leg 12d. The header 9d, the two concentric legs 13d and 12d are integral parts of the tap bodies 2dx and 2dy and can be moulded or casted in a single moulding die or casting die making it cost effective and easy to manufacture commercially.

The tap bodies 2dx and 2dy are hollow tubes extruded at bottom end connecting to both tap bodies 2dx and 2dy and also connected to top end of the outer leg 12d and the inner leg 13d and bottom end of the header 9d and the top end is having inner thread for fixing cartridges 3dx and 3dy inside them respectively as shown in the FIG. 11. Two valve seat tubes 4dxt and 4dyt are an integral part of the tap bodies 2dx and 2dy respectively and also extruded to connect to the outer leg 12d and the inner leg 13d respectively. The upper part of the tap bodies 2dx and 2dy are having large inner diameter and inner thread near top end portion. Their lower portion is curved and designed such that valve seat tubes 4axt and 4ayt protrude inside them, connected to the inner leg 13d and the outer leg 12d respectively and there is one outlet opening 6dx and 6dy towards the header 9d in the bodies 2dx and 2dy respectively for allowing water to enter in the mixing chamber in the header 9d. The tap bodies 2dx and 2dy act as housing for the cartridges 3dx and 3dy respectively. The hollow valve seat tube 4dxt at its top is having valve seat 4dx and bottom end protrudes in the tap body 2dx is also connected to upper end of the inner leg 13d for allowing water to reach up to the valve seat 4dx via the inner leg 13d. The hollow valve seat tube 4dyt at its top is having valve seat 4dx and bottom end protrudes in the tap body 2dy is also connected to upper end of the outer leg 12d for allowing water to enter in the valve seat 4dy via the outer leg 12d. A hexagonal protrude 14d in the outer leg 12d acts as a base for the main body G. Inner surfaces of these valve seat tubes 4dxt and 4dyt are matching with inner surfaces, near connecting area, of the inner leg 13d and the outer leg 12d respectively and allows cold and hot water to enter in the mixer chamber 7d through the outlet 6dx of the tap body 2dx and the outlet 6dy of the tap body 2dy when tap handles 1dx and 1dy are rotated by user for lifting up the washers W3 in the tap cartridges 3dx and 3dy respectively. A threaded end 10d in the header is for connection to pipe fittings like elbow, tee or female hose pipe etc. The hexagonal protrude 8d in the header 9d is for assisting tightening of external pipe fittings e.g. hose connector, elbow or tee joint etc. in the header 9d.

The inner leg 13d is a hollow tube with plain outer surface except threaded end 15d near its bottom end and bent near its top end extruded to connect to the valve seat tubes 4dxt, the tap bodies 2ax and 2ay and top end of the outer leg 12d. The outer diameter of the plain surface of the inner leg 13d is more than the outer diameter of the threaded end 15d of the inner leg 13d.

The outer leg 12d is a hollow tube having threaded first leg 17d near bottom end and threaded tubular second leg 19d in radial direction for connection to hot water supply line and top end is connected to the tap bodies 2dx and 2dy and the inner leg 13d. The first leg 17d is for engaging the female threaded end 1c of the toupling C for the purpose of fixing and tightening the main body G to any suitable pipe fittings i.e. elbow or tee joints etc., through the toupling C, of cold water supply line above washbasin, kitchen sinks, bath tubs etc. or in bathroom, washroom, industries etc. The second leg 19d is for connecting pipe fittings i.e. elbow or tee joints etc. or female ends hose connector of hot water supply line above washbasin, kitchen sinks, bath tubs etc. or in bathroom, washroom, industries etc. There is one hexagonal protrude 14d in the first leg 17d for assisting in tightening pipe fitting or female connector of hose pipe etc. There is one hexagonal protrude 18d in the second leg 19d for assisting in tightening pipe fitting or female connector of hose pipe etc. The other end i.e. top end is connected to the body 2dy and the valve seat tube 4dyt such that there is hollow/open connection between the valve seat 4dy and the second leg 19d and the hot water enter in the valve seat tube 4dyt reaching up to the washer W3 and valve seat 4dy as shown in the FIG. 11. There is no hollow/open connection between the second leg 19d and the valve seat 4dx and no direct hollow/open connection between the second leg 19d and the header 9d.

There is a tubular threaded end 10d near the header 9d, having the hexagonal protrude 8d, for connection to outlet pipe fittings or spout or any other pipe system or fittings.

The inner leg 13d is concentric to the outer leg 12d. The inner leg 13d is inside the outer leg 12d. Top end of both the legs 13d and 12d are bent and extended to connect to the valve seat 4dx and 4dy via the valve seat tubes 4dxt and 4dyt respectively as shown in the cross -sectional view in the FIG. 11. The protrude 14d is in the outer surface of the outer leg 12d to be used as base for the main body G to be fitted on any surface by the toupler C. The inner leg 13d and the outer leg 12d are connected to each other and to the tap bodies 2dx and 2dy in such a way that they allow separately flow of cold and hot water to be mixed in the mixing chamber 7d. This arrangement of the tap bodies 2dx and 2dy, the inner leg 13d, the outer leg 12d and the header 9d is thought of and developed to make it convenient to manufacture these parts of the main body G from probably a single mould die by moulding process or a single cast die by casting process using material like plastic, metal, glass or ceramic raw materials etc. The innovative toupling C is designed to couple the main body G to pipe fittings.

The spindle-washer tap cartridge or ceramic discs tap cartridge 3dx and 3dy are not described in details, in that it is to be considered known and described in the field and can be seen in search engine like google.com by simply writing ‘spindle-washer tap cartridge or ceramic disc tap cartridge’ in search box and clicking on search button. Two washers W3 each are connected to the cartridges 3ax and 3ay sit on valve seats 4dx and 4dy of the tap bodies 2ax and 2ay respectively.

Two tap bodies 2dx and 2dy of the main body G, attachable to pipe fittings by its base 14d through the toupling C above the baths, kitchen sinks, washbasin etc., includes the two concentric legs or tails, the inner leg or tail 13d and the outer leg or tail 12d and the header 9d. The two concentric legs 13d and 12d are connected to each other at their top ends as well as to the tap bodies 2dx and 2dy as shown in the FIG. 3. The bodies 2dx and 2dy further include mixing chamber 7d in the header 9d for mixing the cold and hot water before passing the mixed water to outside of the tap via the threaded end 10d. The amount of water discharged, and the cold and the hot water proportions of the water discharged, are both controlled by two tap handles 1dx and 1dy rotatably attached to the spindle of the tap cartridges 3dx and the 3dy respectively. The tap cartridges 3dx and 3dy are housed and fitted in the tap bodies 2dx and 2dy respectively. The inner leg 13d and the first leg 17d of the outer leg 12d are connected to the toupling C. The hollow disc Z1 and the washer W2 are inserted in the threaded end 15d of the inner leg 13d and stopped near round unthreaded outer surface of the leg 13d. The two concentric legs are inserted in the Toupling C such that the threaded end 15d of the inner leg 13d enters into a hole in the disc seat 4c and the female threaded end 1c screwed in the first leg 17d of the outer leg 12d. There is a washer W4 inserted in the first leg 17d before inserting and screwing in the Toupler C. A nut N2 is tighten in the threaded end 15d of the inner leg 13d. The tightening of the nut N2 is done so that the washer W2 tightly touches the disc seat 4c in such a way that there should not be any water leakage through the disc seat 4c in the outer leg 12d. The second leg 19d of the outer leg 12d is for connection to the hot water.

The first leg 17d of the main body G is attachable to pipe fittings, like elbow or tee joint or any other pipe fittings of cold water supply lines through the Toupling C, in the wall above washbasin, kitchen sinks, bath tabs or in washroom, bathroom or toilet etc. The second leg 19d of the main body G is attachable to pipe fittings, like elbow or tee joint or any other pipe fittings of hot water supply lines either directly or through the female ends hose pipe, in the wall above washbasin, kitchen sinks, bath tubs or in washroom, bathroom or toilet, industries etc. The fluid mixer tap in this embodiment can be fitted in cistern used in toilet for mixed water supply. This 8^{th} embodiment may not be attachable to kitchen sinks, washbasin or bath tubs directly. It can also be fitted to shower.

The cold water enter the tap through the inlet 3c of the first leg 2c and then to an inlet 16d of the inner leg 15d and then the outlet 5dx in the inner leg 13d before entering the valve seat 4dx and if the tap handle 1dx is turned manually by user then the cold water further flowed to a mixing chamber 7d through the outlet 6dx before entering in the header 9d. The hot water enter the tap through an inlet 20d of the second leg 19d and then to an inlet 21d in the outer leg 12d and then to an out let 5dy of the outer leg 12d and enter the valve seat 4dy and if the tap handle 1dy is turned manually by user then the hot water further flowed to a mixing chamber 7d through the outlet 6dy before entering in the header 9d. When both tap handles 1dx and 1dy are turned then the mixed water flows out of the outlet 11d. The hot water and cold water lines connections can be interchanged.

The amount and proportion of the cold and the hot water is controlled by the rotation of the tap handles 1dx and 1dy. When the tap handles 1dx and 1dy are turned in opposite direction than the water shuts off.

In this manner the tap handles 1dx and 1dy can be operated manually by a user, to allow delivery of the water and the mixing of hot water and cold water.

In this embodiment in place of spindle-washer cartridges 3dx and 3dy other types of tap cartridges can also be used.

This design makes the Fluid Mixer Taps or Valves (FMT) cost effective, easy to install and easy to maintain, robust in construction and easy of operation.

### I. Ninth Embodiment

FIG. 12 describes the Ninth Embodiment of the present invention Fluid Mixer Tap or Valve (FMT). Partly cross sectional and partly perspective view of the ninth embodiment of the present invention is shown in FIG. 12.

The fluid mixer tap illustrated in FIG. 12 comprises only a main body H and no Toupling C but still serving the purpose of the eighth embodiment.

The main body H substantially comprises two tap bodies 2ex and 2ey, two tap cartridges 3ex and 3ey, two tap handles 1ex and 1ey, a header 9e, two non concentric tubular legs inner leg 12e and inlet pipe 24e, first leg 15e, second leg 18e and an outer leg 12e. The header 9e, the inner leg 13e, the outer body 12e, the inlet pipe 24e, the first leg 15e and the second leg 18e are integral parts of the tap bodies 2ex and 2ey and can be moulded or casted in a single moulding die or casting die respectively making it cost effective and easy to manufacture commercially.

The main body H of the ninth embodiment is same as that of the main body G of the eighth embodiment with the two tap bodies 2ex and 2ey connected individually to two non concentric inlet legs or tails and are having first leg 15e and second leg 18e as its integral part and is for direct connection to pipe fittings like elbow, tee or female hose pipe etc. for cold and hot water line without need of the Toupling C.

The tap bodies 2ex and 2ey are hollow tubes extended at bottom end connected to the outer leg 12e, the inner leg 13e and the header 9d and other end is having inner threads for fixing cartridges 3ex and 3ey inside the tap bodies 2ex and 2ey respectively as shown in the FIG. 12. The tap body 2ey is also connected to top end of the inlet tubular leg or tail 24e. Two valve seat tubes 4ext and 4eyt are an integral part of the tap bodies 2ex and 2ey respectively and also extruded to connect to the inner leg 13e and the inlet leg 24e respectively. The upper part of the tap bodies 2ex and 2ey are having large inner diameter along with inner thread near top end portion for fixing the tap cartridges 3ax and 3ay respectively. Their lower portion is curved and designed such that the valve seat tubes 4ext and 4eyt protrude inside them, connected to the inner leg 13e and the inlet leg 24e respectively and there are outlet openings 6ex and 6ey in the bodies 2ex and 2ey respectively towards the mixing chamber 7e in the header 9e for allowing water to enter in the mixing chamber 7e in the header 9e before leaving the tap. The tap bodies 2ex and 2ey act as housing for the cartridges 3ex and 3ey respectively. The hollow valve seat tube 4ext at its bottom end protrudes in the tap body 2ex is also connected to upper end of the inner leg 13e for allowing water to reach up to the valve seat 4ex via the inner leg 13e. The hollow valve seat tube 4eyt at its bottom end protrudes in the tap body 2ey is also connected to upper end of the inlet leg 24e for allowing water to enter in the valve seat 4ey via the inlet leg 24e. A hexagonal protrude 14e in the outer leg 12e near first leg 15e acts as a base for the main body H. The outer leg 12e and the inner leg 13e are connected by connecting plates 22e and 23e in addition to other connecting means available. Inner surfaces of these valve seat tubes 4ext and 4eyt are matching with inner surfaces near connecting area of the inner leg 13e and the inlet leg 24e respectively and allows cold and hot water to enter in the mixer chamber 7e through the outlet 6ex of the tap body 2ex and the outlets 6ey, 6eya and 6eyb of the tap body 2ey when tap handles 1ex and 1ey are rotated by user for lifting up the cartridges 3ex and 3ey respectively. A threaded end 10e in the header 9e is for connection to pipe fittings like elbow, tee or female hose pipe etc. The mixed water discharged through the outlet 11e.

The inner leg 13e is a hollow tube with bottom end connected to the first leg 15e and opposite end bent near its top extruded to connect to the valve seat tubes 4ext which is extruded and connected to the valve seat 4ex. The inner leg 13e is also connected radially to the outer leg 12e by connecting plates 22e and 23e and to the tap body 2ey as shown in the FIG. 12. Cold water enter through the first leg 15e reaches up to the valve seat 4ex and the washer W3 seating on the valve seat 4ex.

The outer body or leg 12e is a hollow tube having threaded first leg 15e near bottom end in axial direction and threaded tubular second leg 18e in radial direction for connection to cold and hot water lines respectively. The other end of the outer body 12e is having header 9e. The first leg 15e is for connecting the main body H to any suitable pipe fittings i.e. elbow or tee joints etc. of cold water supply line above washbasin, kitchen sinks, bath tubs etc. or in bathroom, washroom, industries etc. or in shower pipe line etc. The second leg 18e is for connecting pipe fittings i.e. elbow or tee joints etc. or female ends hose connector of hot water supply line above washbasin, kitchen sinks, bath tubs etc. or in bathroom, washroom, industries etc. or in shower pipe line. There is one hexagonal protrude 14e in the first leg 15e for assisting in tightening pipe fitting or female connector of hose pipe. There is one hexagonal protrude 17e in the second leg 18e for assisting in tightening pipe fitting or female connector of hose pipe.

Top end of the inlet leg 24e is connected to the body 2ey and the valve seat tube 4eyt and bottom end is connected and open in the second leg 18e such that hot water enter in the valve seat tube 4eyt reaching up to the washer W3/valve seat 4ey when the tap is closed as shown in the FIG. 12. The washer is connected to the cartridge 3ey and sit on the valve seat 4ey.

There is a tubular threaded end 10e near the header 9e having the hexagonal protrude 8e for connection to outlet pipe fittings or spout or any other system.

The spindle-washer tap cartridge or ceramic discs tap cartridge 3ex and 3ey are not described in details, in that it is to be considered known and described in the field and can be seen in search engine like google.com by simply writing ‘spindle-washer tap cartridge or ceramic disc tap cartridge’ in search box and clicking on search button. Two washers W3 each are connected to the cartridges 3ex and 3ey sit on valve seats 4ex and 4ey of the tap bodies 2ex and 2ey respectively.

The tap bodies 2ex and 2ey of the main body H, attachable to pipe fittings by its base 14e above the baths, kitchen sinks, washbasin or in pipe line for shower etc., includes the inner leg or tail 13e, the outer leg or tail 12e, the inlet leg 24e, the first leg 15e, the second leg 24e and the header 9e. The two concentric legs 13e and 12e are connected to each other near their top end and bottom end by connecting plates 23e and 22e respectively as well as to the tap bodies 2ex and 2ey and the header 9e as shown in the FIG. 12. The bodies 2ex and 2ey further include mixing chamber 7e in the header 9e for mixing the cold and hot water before passing the mixed water to outside of the tap via the threaded outlet end 10e. The amount of water discharged, and the cold and the hot water proportions of the water discharged, are both controlled by the two tap handles 1ex and 1ey rotatably attached to spindle of the tap cartridges 3ex and the 3ey respectively. The tap cartridges 3ex and 3ey are housed and fitted in the tap bodies 2ex and 2ey. The first leg 15e is for connection to the cold water line and the second leg 18e of the outer leg 12e is for connection to the hot water line.

The first leg 15e of the main body G is attachable to pipe fittings, like elbow or tee joint or any other pipe fittings of cold water supply lines in the wall above washbasin, kitchen sinks, bath tabs or in washroom, bathroom or toilet etc. The second leg 18e of the main body H is attachable to pipe fittings, like elbow or tee joint or any other pipe fittings of hot water supply lines either directly or through the female ends hose pipe, in the wall above washbasin, kitchen sinks, bath tubs or in washroom, bathroom or toilet, industries etc. The fluid mixer tap in this embodiment can be fitted in cistern used in toilet for mixed water supply. The ninth embodiment may not be attachable to kitchen sinks, washbasin or bath tubs directly. It can also be fitted to shower.

The cold water enter the tap through the inlet 16e of the first leg 15e and then inside 21e of the inner leg 13e and then the outlet 5ex in the inner leg 13e before entering the valve seat 4ex and if the tap handle 1ex is turned manually by user then the cold water further flowed to a mixing chamber 7e through the outlet 6ex of the tap body 2ex before entering in the header 9e and discharged through the tap. The hot water enter the tap through the inlet 19e of the second leg 18e and then to the inlet 20e in the inlet leg 24e and then to the outlet 5ey of the inlet leg 24e and enter the valve seat 4ey and if the tap handle 1ey is turned manually by user then the hot water further flowed to the mixing chamber 7e through the outlet 6ey, 6eya and 6eyb of the tap body 2ey before discharged through the outlet 11e. Hot water and cold water lines connections can be interchanged.

The amount and proportion of cold and hot water is controlled by rotation of the tap handles 1ex and 1ey. When the tap handles 1ex and 1ey are turned in opposite direction then the water shuts off.

In this manner the tap handles 1ex and 1ey can be operated manually by a user, to allow delivery of the water and the mixing of hot water and cold water.

In this embodiment in place of spindle-washer cartridges 3ex and 3ey other types of tap cartridges can also be used.

This design makes the fluid mixer taps (valves) cost effective, easy to install and easy to maintain, robust in construction and ease of operation.

### J. Tenth Embodiment

FIG. 13 describes the Tenth Embodiment of the present invention Fluid Mixer Taps or Valves (FMT). Partly cross sectional and partly perspective view of the tenth embodiment of the present invention is shown in FIG. 13.

The Fluid Mixer Tap illustrated in FIG. 13 comprises only the main body M and no Toupling C or Taptee T.

The main body M of the tenth embodiment is same as that of the main body H of the eighth embodiment except one additional third tap body 2ez, cartridge 3ez, inlet leg 29e, tap handle 1ez and third leg 25e connected to the outer body 12e′.

The main body M substantially comprises three tap bodies 2ex, 2ey and 2ez, three tap handles 1ex, 1ey and 1ez, three tap cartridges 3ex, 3ey and 3ez, a header 9e, three non concentric tubular legs inner leg 13e′, inlet pipe legs 24e and 29e, first leg 15e, second leg 18e, third leg 25e and an outer leg 12e′.

The tap bodies 2ex, 2ey and 2ez are hollow tubes extruded at bottom end connected to the outer tubular body or leg/pipe 12e′, the inner leg 13e′ and the header 9e and other end is having inner threads for fixing cartridges 3ex, 3ey and 3ez inside them respectively as shown in the FIG. 13. The tap bodies 2ey and 2ez are also connected to the inlet tubular legs or tails 24e and 29e respectively. Three valve seat tubes 4ext, 4eyt and 4ezt are an integral part of the tap bodies 2ex, 2ey and 2ez respectively extruded to connect to the inner leg 13e′, the inlet leg 24e and the inlet leg 29e respectively and top end is connected to the valve seat 4ex, 4ey and 4ez respectively. The upper part of the tap bodies 2ex, 2ey and 2ez are having large inner diameter along with inner thread near top end portion for housing the tap cartridges 3ex, 3ey and 3ez respectively. Their lower portion is curved and designed such that the valve seat tubes 4ext, 4eyt and 4ezt protrude inside them, connected to the inner leg 13e, the inlet legs 24e and the inlet leg 29e respectively and there are outlet openings 6ex, 6eya & 6eyb and 6eza & 6ezb in the bodies 2ex, 2ey and 2ez respectively towards the mixing chamber 7e in the header 9e for allowing water to enter in the mixing chamber 7e and discharged through the outlet 11e. The tap bodies 2ex, 2ey and 2ez act as housing for the cartridges 3ex, 3ey and 3ez respectively. The hollow valve seat tube 4ext at its bottom end protrudes in the tap body 2ex is also connected to upper end of the inner leg 13e′ for allowing water to reach up to the valve seat 4ex through the first leg 15e and the inner leg 13e′. The hollow valve seat tube 4eyt at its bottom end protrudes in the tap body 2ey is also connected to upper end of the inlet leg 24e for allowing water to enter in the valve seat 4ey via the inlet leg 24e through the second leg 18e. The hollow valve seat tube 4ezt at its bottom end protrudes in the tap body 2ez is also connected to upper end of the inlet leg 29e for allowing water to enter in the valve seat 4ez via the inlet leg 29e through the third leg 25e. A hexagonal protrude 14e in the outer leg/body 12e′ near the first leg 15e acts as a base for the main body M. The outer body 12e′ and the inner leg 13e′ are connected by connecting plates 23e in addition to other connecting means available from the tap bodies 2ey and 2ez as shown in the FIG. 13. Inner surfaces of these valve seat tubes 4ext, 4eyt and 4ezt are matching with inner surfaces near connecting area of the inner leg 13e′, the inlet leg 24e and the inlet leg 29e respectively and allows cold, hot and raw water to enter in the mixer chamber 7e through the outlet 6ex of the tap body 2ex, the outlets 6ey, 6eya & 6eyb of the tap body 2ey and the outlet 6ez, 6eza & 6ezb of the tap body 2ez when tap handles 1ex, 1ey and 1ez are rotated by user for lifting up the washers W3 of the cartridges 3ex, 3ey and 3ez respectively. A threaded end 10e in the outer body 12e′ is for connection to pipe fittings like elbow, tee or female hose pipe etc.

The inner leg 13e′ is a hollow tube with bottom end connected to the outer leg 12e′ opened in the first leg 15e and other end bent near its top end extruded to connect to the valve seat tubes 4ext which is further extruded and connected to the valve seat 4ex. The inner leg 13e′ is also connected radially to the outer leg 12e′ by connecting plate 23e and tap bodies 2ex, 2ey and 2ez as shown in the FIG. 13. Cold water enter through the first leg 15e reaches up to the valve seat 4ex and the washer W3 seating on the valve seat 4ex.

The outer body or leg 12e′ is a hollow tube having threaded first leg 15e near bottom end in axial direction, threaded tubular second leg 18e and threaded tubular third leg 25e in radial direction for connection to cold and hot water lines respectively. The first leg 15e is for connecting the main body M to any suitable pipe fittings i.e. elbow or tee joints etc. of cold water supply line above washbasin, kitchen sinks, bath tubs etc. or in bathroom, washroom, industries etc. or in shower pipe line. The second leg 18e is for connecting pipe fittings i.e. elbow or tee joints etc. or female ends hose connector of hot water supply line above washbasin, kitchen sinks, bath tubs etc. or in bathroom, washroom, industries etc. or in shower pipe line. The third leg 25e is for connecting pipe fittings i.e. elbow or tee joints etc. or female ends hose connector of raw water supply line above washbasin, kitchen sinks, bath tubs etc. or in bathroom, washroom, industries etc. or in shower pipe line. There is one hexagonal protrude 14e in the first leg 15e for assisting in tightening pipe fitting or female connector of hose pipe. There is one hexagonal protrude 17e in the second leg 18e for assisting in tightening pipe fitting or female connector of hose pipe. There is one hexagonal protrude 26e in the third leg 25e for assisting in tightening pipe fitting or female connector of hose pipe.

Top end of the inlet leg 24e is connected to the body 2ey and the valve seat tube 4eyt and bottom end is connected and open in the second leg 18e such that the hot water enter in the valve seat tube 4eyt reaching up to the washer W3/valve seat 4ey when the tap is closed as shown in the FIG. 13. The washer is connected to the cartridge 3ey and sit on the valve seat 4ey.

Top end of the inlet leg 29e is connected to the body 2ez and the valve seat tube 4ezt and bottom end is connected and open in the third leg 25e such that the raw water enter in the valve seat tube 4ezt reaching up to the washer W3/valve seat 4ez when the tap is closed as shown in the FIG. 13. The washer is connected to the cartridge 3ez and sit on the valve seat 4ez.

There is a tubular threaded end 10e near the header 9e having the hexagonal protrude 8e for connection to outlet pipe fittings or spout or any other system.

The spindle-washer tap cartridge or ceramic discs tap cartridge 3ex, 3ey and 3ez are not described in details, in that it is to be considered known and described in the field and can be seen in search engine like google.com by simply writing ‘spindle-washer tap cartridge or ceramic disc tap cartridge’ in search box and clicking on search button. Three washers W3 each are connected to the cartridges 3ex, 3ey and 3ez sit on valve seats 4ex, 4ey and 4ez of the tap bodies 2ex, 2ey and 2ez respectively.

The tap bodies 2ex, 2ey and 2ez of the main body M, attachable to pipe fittings by its base 14e in the pipe fittings in the wall above the baths, kitchen sinks, washbasin or in pipe line for shower etc., includes the inner leg or tail 13e′, the outer leg or tail 12e′, the inlet leg 24e, the inlet leg 29e, the first leg 15e, the second leg 24e, the third leg 25e and the header 9e. The two concentric legs 13e′ and 12e′ are connected to each other at their top end by the connecting plate 23e as well as to the tap bodies 2ex, 2ey and 2ez as shown in the FIG. 13. The bodies 2ex, 2ey and 2ez further include mixing chamber 7e in the header 9e for mixing cold, hot and raw water before discharging the mixed water to outside of the tap via the outlet 11e. The amount of water discharged, and cold, hot and raw water proportions of the water discharged, are both controlled by three tap handles 1ex, 1ey and 1ez rotatably attached to the spindle of the tap cartridges 3ex, the 3ey and the 3ez respectively. The tap cartridges 3ex, 3ey and 3ez are housed and fitted in the tap bodies 2ex, 2ey and 2ez. The first leg 15e is for connection to the cold water line, the second leg 18e is for connection to the hot water line and the third leg 25e is for connection to the raw water line.

The first leg 15e of the main body G is attachable to pipe fittings, like elbow or tee joint or any other pipe fittings of cold water supply lines in the wall above washbasin, kitchen sinks, bath tabs or in washroom, bathroom or toilet etc. The second leg 18e and the third leg 25e of the main body M are attachable separately to pipe fittings, like elbow or tee joint or any other pipe fittings of hot water supply line and raw water line respectively either directly or through the female ends hose pipe, in the wall above washbasin, kitchen sinks, bath tubs or in washroom, bathroom or toilet, industries etc. The fluid mixer tap in this embodiment can be fitted in cistern used in toilet for mixed water supply. The 10th embodiment may not be attachable to kitchen sinks, washbasin or bath tubs directly. It can also be fitted to shower.

The cold water enter the tap through the inlet 16e in the first leg 15e and then inside 21e of the inner leg 13e′ and then the outlet 5ex in the inner leg 13e′ before entering the valve seat 4ex and if the tap handle 1ex is turned manually by user then the cold water further flowed to a mixing chamber 7e through the outlet 6ex before entering in the header 9e and discharging through the outlet 11e. The hot water enter the tap through the inlet 19e of the second leg 18e and then to an inlet 20e in the inlet leg 24e and then to an out let 5ey of the inlet leg 24e and enter the valve seat 4ey and if the tap handle 1ey is turned manually by user then the hot water further flowed to a mixing chamber 7e through the outlet 6ey, 6eya, 6eyb before discharging through the outlet 11e. The raw water enter the tap through the inlet 27e of the second leg 25e and then to the inlet 28e in the inlet leg 29e and then to an outlet 5ez of the inlet leg 29e and then enter the valve seat 4ez and if the tap handle 1ez is turned manually by user then the raw water further flowed to a mixing chamber 7e through the outlet 6ez, 6eza, 6ezb before discharging through the outlet 11e. Hot, cold and raw water lines connections can be interchanged.

The amount and proportion of cold, hot and raw water is controlled by the rotation of the tap handles 1ex, 1ey and 1ez respectively. When the tap handles 1ex, 1ey and 1ez are turned in opposite direction then the water shuts off.

In this manner the tap handles 1ex, 1ey and 1ez can be operated manually by a user, to allow delivery of the water and the mixing of hot water, cold water and raw water.

In this embodiment in place of spindle-washer cartridges 3ex, 3ey and 3ez other types of tap cartridges can also be used.

This design makes the Fluid Mixer Taps or Valves (FMT) cost effective, easy to install and easy to maintain, robust in construction and easy in operation.

### K. Eleventh Embodiment

FIG. 15 describes the Eleventh Embodiment of the present invention Fluid Mixer Tap (FMT). Partly cross sectional and partly perspective view of the eleventh embodiment of the present invention is shown in FIG. 15.

The Fluid Mixer Tap illustrated in FIG. 15 comprises only the main body A″ and no Toupling C or Taptee T required for connection to cold and hot water lines.

The main body A″ of the eleventh embodiment is same as that of the main body A of the first embodiment except one additional threaded hollow female socket 9″ extruded in radial direction from the inner leg 8″ and then a cut in the outer leg or tail 7″ as shown in the FIG. 15.

The tap body 2, the tap handle 1, the spout 14, the cartridge 3, the inner ring Ra, the outer ring Rb, the inner valve seat 4a, the outer valve seat 4b, the mixing chamber 20, the nut N1 and the washer W1 are same as that in the first embodiment of the present invention. The only difference in the first and eleventh embodiment is in the outer leg 7 and the inner leg 8 and the spout 14 of the first embodiment.

The main body A″ substantially comprises the tap body 2, the tap handle 1, the tap cartridge 3, the outlet spout 14 and the two concentric tubular legs or tails named inner leg 8″ and outer leg 7″. The spout 14 and the two concentric legs 7″ and 8″ connected by the plates 6″ are an integral part of the tap body 2 and can be moulded or casted in a single moulding die or casting die.

The inner leg 8″ is a hollow tube with plain outer surface bent near its bottom end and opened through the outer leg 7″ in radial direction for connection to hot water supply line as shown in the FIG. 15.

The outer leg 7″ is a hollow tube having threaded outer surface for engaging the nut N1 for the purpose of fixing and tightening the main body A″ to a surface of washbasin, kitchen sinks, bath tubs or any other surface by screwing the nut N1. There is one hole near its bottom in radial direction for the second leg 9 for connection to hot water supply line.

Top diametrical surface of both the legs 8″ and 7″ are extruded to connect to the valve seat 4a and 4b respectively.

The spout 14 is a hollow long tube with one end connected to the lateral surface of the tap body 2 having radial opening coaxial to the spout 14 and other end is open with outlet 15 for discharge of mixed water from the tap. The end cap 15 is inserted and fixed in the end of the spout 14 as shown in the FIG. 15.

The tap body 2 is a hollow tube with two rings. The upper ring of the tap body 2 is having large inner diameter along with inner thread near top portion for fixing the tap cartridge 3 and one radial hole in its lateral surface with or without inner thread for connecting the spout 14. The tap body 2 acts as housing for the cartridge 3. The lower ring of the tap body 2 is having two concentric holes coaxially aligned to two concentric tubular valve seats 4a and 4b respectively. The inner valve seat 4a is coaxially extruded to connect to top end of the inner leg 8″ via inner hole in the lower ring of the tap body 2 and the outer valve seat 4b is coaxial to the tubular outer leg 7″ and extruded to touch upper surface of the lower ring of the tap body 2. The outer leg 7″ is opened in the outer valve seat 4b. The lower ring also acts as a base for the main body A″ and along with the outer leg 7″ is used for fixing the tap to the supporting surface of wash stand or bath stand or kitchen sink by using a nut N1. Inner surfaces of these valve seats 4a and 4b are connected with inner surfaces of the inner leg 8″ and the outer leg 7″ respectively allowing water to enter in two concentric ports, inner port 3h and outer port 3g, in the bottom ceramic disc K2 of the cartridge 3 respectively. The outlet tubular spout 14 coaxial with the radial hole in the tap body 2 allowing mixed water to enter in the spout 14 before delivery through the outlet 15 in the spout 14 is connected to lateral surface of the body 2.

The inner leg 8″ is a hollow tube concentric and inside the outer leg 7″ with bottom end bent in radial direction connecting to the outer leg 7″ in radial direction with inner threaded end female socket named second leg 9″ for connection to hot water supply line. The inner leg 8″ and the outer leg 7″ are connected to each other by four or three connecting plates 6″ in radial direction. This arrangement of the tap body 2, the inner leg 8″, the outer leg 7″, the connecting plates 6″, the second leg 9″ and the spout 14 is thought of, invented and developed to make it convenient to manufacture these parts of the main body A″ from probably a single mould die by moulding process or a single cast die by casting process using material like plastic, metal, glass or ceramic raw materials etc. in addition to its simple connection to surface of kitchen sink, washbasin, bathtubs etc. and economical in cost and easy to install and maintain. In addition the female socket second leg 9″ is innovated for ease of connection of the main body A″ to hot water supply line. The tap body 2 can be made of metals or plastic or PVC or any other suitable solid material. These are innovative things which can not be found in the existing prior art water mixer taps.

There is one end cap 16 fixed at top end of the spout 14 so that mixed water should not pass through this end and discharge only through an opening/outlet 15 in the spout 14.

The mono block ceramic discs tap cartridge 3 is shown in the FIG. 20. It is same as that explained in the first embodiment and hence not explained in here.

The two concentric retaining washers or O-rings Ra and Rb are fixed in the cartridge 3 and touches the inner valve seat 4a and the outer valve seat 4b respectively and acts as seal between the inner valve seat 4a and the outer valve seat 4b. These two washers or O-rings Ra and Rb stop any water leakage from one leg 7″ to other leg 8″ towards their top end edge and allow mixed water to outlet 15 when two concentric ports 3h and 3g are open due to rotation of the tap handle 1.

A securing washer W1 and a back nut Ni inserted in the outer leg 7″ below base of the tap body 2 is to secure the main body A″ of the tap to supporting surface of a wash-stand like washbasin, kitchen sinks or bath tubs etc.

The main body A″, attachable to the baths, kitchen sinks, washbasin etc., includes the tap body 2, the two concentric legs or tails, the inner leg or tail 8″ bent at its bottom end connected to the outer leg 7″ in radial direction and the outer leg or tail 7″, connected to each other near their top end by three or four rectangular plates 6″ in radial direction or any other means 6″, connected at bottom side of the tap body 2 and the spout 14 at the circumferential side. The main body A″ further includes mixing chamber 20 for mixing hot and cold water before passing the mixed water to outside of the tap via the spout 14 and then by the outlet 15. The amount of water discharged, and the hot and the cold water proportions of the water discharged, are both controlled by the tap handle 1 rotatably attached to the spindle 3f of the tap cartridge 3. The tap cartridge 3 is housed and fitted in the tap body 2 having concentric ports/holes in the bottom ceramic discs K2. The ceramic discs tap cartridge 3 is illustrated in the FIG. 20. The first leg 12″ in the outer leg 7″ is for connection to cold water supply line through female hose connector or any other suitable pipe fittings like elbow, tee joints etc. where as the second leg 9″ is for connection to hot water line through male-female hose connector or through any suitable pipe fittings like nipple, elbow or tee joints etc.

The hot water enter the tap (FMT) through the inlet 10″ of the second leg 9″ and then the outlet 11″ in the inner leg 8″ and then inner port 3h in the cartridge 3 and if the tap handle 1 is turned manually by user then the hot water further flowed to the mixing chamber 20 before entering in the spout 14. The cold water enter the tap through the inlet 13″ of the first leg 12″ and then to an out let 5″ of the outer leg 7″ and then enter into the outer port 3g in the cartridge 3 and if the tap handle 1 is turned manually by user then the cold water further flowed to the mixing chamber 20 before entering in the spout 14 and discharged through the outlet 15. When the tap handle 1 rotates, upper ceramic disc (moving) K1 in the cartridge 3 also rotates and the two concentric ports/holes 3h and 3g in the lower disc K2 opened and allow hot and cold water flow out of the cartridge 3 to be mixed in the mixing chamber 20 and discharged through the spout 14. Hot water and cold water lines connections can be interchanged.

The amount and proportion of hot and cold water is controlled by rotation of the tap handle 1. When the tap handle 1 is turned in opposite direction than the water shuts off.

In this manner the tap handle 1 can be operated manually by a user, to allow delivery of the water and at the same time mixing of hot water and cold water.

In this embodiment in place of ceramic discs cartridge 3 other types of tap cartridges can also be used having concentric rubber washer or any other type of washers or made of any other materials.

The spout 14 can be separately manufactured with additional features like inner thread socket near end of the tap body and screwed/connected to additional features like threaded header in lateral surface in the tap body 2. This is not disclosed but any person having common sense or knowledge can make it.

The spout 14 may not be integral part of the tap body 2 but can be received by making inner thread in the radial hole in the lateral surface of the tap body 2 coaxial to the tubular outlet spout 14 having threaded spigot with lower diameter than outer diameter of the spout 14 in some other embodiments which are not disclosed in this present invention.

This design makes the Fluid Mixer Taps (FMT) cost effective, easy to install and easy to maintain, robust in construction and ease of operation.

### L. Twelfth Embodiment

FIG. 16 describes the Twelfth Embodiment of the present invention Fluid Mixer Tap or Valve (FMT). Partly cross sectional and partly perspective view of the twelfth embodiment of the present invention is shown in FIG. 16.

The Fluid Mixer Tap illustrated in FIG. 16 comprises only the main body A″′ and no Toupling C or Taptee T required for connection to cold and hot water lines.

The main body A″' of the twelfth embodiment is same as that of the main body A″ of the eleventh embodiment except some minor changes in the spout 14, in the lower portion of the inner leg 6″, the outer leg and the first leg 12″ and the second leg 9″ as evident from the FIG. 15 and the FIG. 16. In this embodiment instead of spout 14 there is one header 14″′ connected to the tap body 2, the first leg 12″′ and the second leg 9″′ connected to the outer leg 7″′ and the inner leg 8″′ respectively in radial direction as shown in the FIG. 16.

The tap body 2, the tap handle 1, the header 14″′, the cartridge 3, the inner ring Ra, the outer ring Rb, the inner valve seat 4a, the outer valve seat 4b, the mixing chamber 20 are same as that in the eleventh embodiment of the present invention. The only difference in the eleventh and the twelfth embodiment is in lower portion of the outer leg 7″ and the inner leg 8″ and the spout 14.

The main body A″′ substantially comprises the tap body 2, the tap handle 1, the tap cartridge 3, the outlet header 14″′ and the two concentric tubular legs or tails named inner leg 8″′ and outer leg 7″. The header 14″′ and the two concentric legs 7″′ and 8″′ connected by the plates 6″′ and the first leg 12″′ and the second leg 9″′ are an integral part of the tap body 2 and can be moulded or casted in a single moulding die or casting die.

The inner leg 8″′ is a hollow tube with plain outer surface bent near its bottom end and opened through the outer leg 7″′ in radial direction and connected to the second leg 9″′ for connection to hot water supply line as shown in the FIG. 16.

The outer leg 7″′ is a hollow tube having plain outer surface bent at its bottom and connected to the first leg 12″′. The first leg 12″′ is a hollow tube having threaded outer surface with one hexagonal edge 19″′ is for connection to cold water supply line. The other end of the first leg 12″′ is connected to the outer leg 7″′ in radial direction and opened in it for flow of water/fluids inside the outer leg 7″. There is one hole near its bottom in radial direction for the second leg 9″′ for connection to hot water supply line.

Top diametrical surface of both the legs 8″ and 7″ are extruded to connect to the valve seat 4a and 4b respectively.

The header 14″′ is a hollow long tube with one end connected to the lateral surface of the tap body 2 having radial opening coaxial to the header 14″′ and other end is open with threaded outlet 16″′ for discharge of mixed water from the tap. There is one hexagonal protrudes 17″′ in the header 14″′.

The tap body 2 is a hollow tube with two rings. The upper ring of the tap body 2 is having large inner diameter along with inner thread near top portion for fixing the tap cartridge 3 and one radial hole in its lateral surface with or without inner thread for connecting the header 14″′. The tap body 2 acts as housing for the cartridge 3. The lower ring of the tap body 2 is having two concentric holes coaxially aligned to two concentric tubular valve seats 4a and 4b respectively. The inner valve seat 4a is coaxially extruded to connect to top end of the inner leg 8″′ via inner hole in the lower ring of the tap body 2 and the outer valve seat 4b is coaxial to the tubular outer leg 7″′ and extruded to touch upper surface of the lower ring of the tap body 2. The outer leg 7″′ l is opened in the outer valve seat 4b. Inner surfaces of these valve seats 4a and 4b are connected with inner surfaces of the inner leg 8″ and the outer leg 7″ respectively allowing water to enter in two concentric ports, inner port 3h and outer port 3g, in the bottom ceramic disc K2 of the cartridge 3 respectively. The outlet tubular header 14″′ coaxial with the radial hole in the tap body 2 allowing mixed water to enter in the header 14″′ before delivery through the outlet 16″′ in the header 14″′ is connected to lateral surface of the body 2.

The inner leg 8″′ is a hollow tube concentric and inside the outer leg 7″′ with bottom end bent in radial direction connecting to the second threaded leg 9″′ through a hole in the outer leg 7″′ in radial direction for connection to hot water supply line. The inner leg 8″′ and the outer leg 7″′ are connected to each other by four or three connecting plates 6″′ in radial direction. This arrangement of the tap body 2, the inner leg 8″′, the outer leg 7″′, the connecting plates 6″′, the second leg 9″′, the first leg 12″′ and the header 14″′ is thought of, invented and developed to make it convenient to manufacture these parts of the main body A″′ from probably a single mould die by moulding process or a single cast die by casting process using material like plastic, metal, glass or ceramic raw materials etc. The tap body 2 can be made of metals or plastic or PVC or any other suitable solid material. These are innovative things which can not be found in the existing prior art water mixer taps.

The mono block ceramic discs tap cartridge 3 is shown in the FIG. 20. It is same as that explained in the first embodiment and hence not explained in here.

The two concentric retaining washers or O-rings Ra and Rb are fixed in the cartridge 3 and touches the inner valve seat 4a and the outer valve seat 4b respectively and acts as seal between the inner valve seat 4a and the outer valve seat 4b. These two washers or O-rings Ra and Rb stop any water leakage from one leg 7″′ to other leg 8″′ towards their top end edge and allow mixed water to outlet 16 when two concentric ports 3h and 3g are open due to rotation of the tap handle 1.

The main body A″′, attachable to pipe system, includes the tap body 2, the two concentric legs or tails, the inner leg or tail 8″′ bent at its bottom end connected to the second leg 9″′ through the hole in the outer leg 7″ in radial direction and the outer leg or tail 7″ bent at its bottom end and connected to the first leg 12″′, connected to each other near their top end by three or four rectangular plates 6″′ in radial direction or any other means 6″′, connected at bottom side of the tap body 2 and the outlet header 14″′ at the circumferential side. The main body A″′ further includes mixing chamber 20 for mixing hot and cold water before passing mixed water to outside of the tap via the header 14″′ and then by the outlet 16″′. The amount of water discharged, and the hot and the cold water proportions of the water discharged, are both controlled by the tap handle 1 rotatably attached to the spindle 3f of the tap cartridge 3. The tap cartridge 3 is housed and fitted in the tap body 2 having concentric ports/holes in the bottom ceramic discs K2. The ceramic discs tap cartridge 3 is illustrated in the FIG. 20. The first leg 12″′ in the outer leg 7″′ is for connection to cold water supply line through female hose connector or any other suitable pipe fittings like elbow, tee joints etc. where as the second leg 9″′ is for connection to hot water line through female-female hose connector or through any suitable pipe fittings like nipple, elbow or tee joints etc.

The hot water enter the tap (FMT) through the inlet 10″′ of the second leg 9″′ and then the outlet 11″′ in the inner leg 8″′ and then inner port 3h in the cartridge 3 and if the tap handle 1 is turned manually by user then the hot water further flowed to the mixing chamber 20 before entering in the header 14″′. The cold water enter the tap through the inlet 13″′ of the first leg 12″′ and then to an out let 5″′ of the outer leg 7″′ and then enter into the outer port 3g in the cartridge 3 and if the tap handle 1 is turned manually by user then the cold water further flowed to the mixing chamber 20 before entering in the header 14 and discharged through the outlet 15″′ in the outlet header 16″′. When the tap handle 1 rotates, upper ceramic disc (moving) K1 in the cartridge 3 also rotates and the two concentric ports/holes 3h and 3g in the lower disc K2 opened and allow hot and cold water flow out of the cartridge 3 to be mixed in the mixing chamber 20 and discharged through the header 14″′. Hot water and cold water lines connections can be interchanged.

The amount and proportion of hot and cold water is controlled by rotation of the tap handle 1. When the tap handle 1 is turned in opposite direction than the water shuts off.

In this manner the tap handle 1 can be operated manually by a user, to allow delivery of the water and at the same time mixing of hot water and cold water.

In this embodiment in place of ceramic discs cartridge 3 other types of tap cartridges can also be used having concentric rubber washer or any other type of washers or made of any other materials.

The header 14″′ can be separately manufactured with additional features like inner thread socket near end of the tap body and screwed/connected to additional features like threaded header in lateral surface in the tap body 2. This is not disclosed but any person having common sense or knowledge can make it.

The header 14″′ may not be integral part of the tap body 2 but can be received by making inner thread in the radial hole in the lateral surface of the tap body 2 coaxial to the tubular outlet header 14″′ having threaded spigot with lower diameter than outer diameter of the header 14 in some other embodiments which are not disclosed in this present invention.

This design makes the Fluid Mixer Taps (FMT) cost effective, easy to install and easy to maintain, robust in construction and ease of operation.

### M. Further Embodiments

FIG. 21 describes the another embodiment of for lower portion of the inner leg 8 in the FIG. 1 and 2; the inner leg 15a in the FIG. 3, 4, 5, 6 and 7; the inner leg 6b in the FIGS. 8, 9 and 10 or the inner leg 13d in the FIG. 11. These inner legs 8, 15a, 6b or 13d can be replaced by the inner leg 8z as shown in the FIG. 21 in further embodiments of the present invention FMT.

Top end of the upper tubular portion 8za of the inner leg 8z is connected to bottom end of the lower portion of the inner leg 8 in the FIG. 1 and 2; the inner leg 15a in the FIG. 3, 4, 5, 6 and 7; the inner leg 6b in the FIGS. 8, 9 and 10 or the inner leg 13d in the FIG. 11.

The upper portion 8za of the 8z is with hose barb tube Sze having tapered stub with ridges at its bottom end.

The lower portion 8zb of the inner leg 8z is with the hose barb tube 8zf at the top, and male pipe threads at bottom and the disc protrude 8zd as shown in the FIG. 21.

The lower portion 8z is mainly comprises of the upper portion 8za coupled to the lower portion 8zb by the flexible pipe connector 8zc as shown in the FIG. 21.

The advantage of the above arrangement is that the breakage/damage of the inner leg 8 in the FIG. 1 and 2; the inner leg 15a in the FIG. 3, 4, 5, 6 and 7; the inner leg 6b in the FIGS. 8, 9 and 10 or the inner leg 13d in the FIG. 11 due to tightening or loosening of the Taptee T or Toupler C as per respective above embodiments can be completely avoided.

The washer W2 is inserted in the lower portion 8zb and then the lower portion 8zb is inserted in the valve seat 9t of the Taptee T or the valve seat 4c of the Toupler C as per the case in the various embodiments above. The Taptee T or the Toupler C is tighten with the main body as per the case in the above various embodiments and then the nut N2 is screwed in the 8zb and then tighten in such a way that there should not be leakage of water or fluids from inner leg to inside of the outer leg in the above various respective embodiments described above.

1. A fluid mixer tap or valve, to be used in kitchen sinks, washbasins, bath tubs, washrooms, bathrooms, hospitals or industries according to various embodiments of the present invention Fluid Mixer Tap or Valve having fewer parts , for mixing hot and cold fluid or water, comprising:
one main body (A, D, E or A′) and taptee (T), one main body (B, F, B′ or G) and toupling (C) or one main body (H, M, A″ or A″′);
wherein the main body (A, D, E, A′, A″) is fitted in washbasin or kitchen sink by means of a nut (N1) screwed in an outer leg (7, 14a, 14a, 7b, 7″) , substantially as herein before described with reference to first, third, fourth, sixth and eleventh embodiments respectively of the accompanying description;
wherein the main body (B, F, B′, G) is fitted in fluid/water piping system above wash basin, kitchen sink, bathrooms etc. using toupling (C) screwed in an outer leg (7′, 14a′, 7b′, 12d), substantially as herein before described with reference to second, fifth, seventh and eighth embodiments respectively of the accompanying description;
wherein the main body (H, M, A′″) is the present invention the fluid mixer tap or valve and can be fitted in fluid/water pipe lines system using couplers, tees or elbows or any other suitable pipe fittings or connections , substantially as herein before described with reference to ninth, tenth and twelfth embodiments respectively of the accompanying description;
wherein the main body (A, B, A″, A″′) comprising of one tap body (2), one tap cartridge (3), one tap handle (1), a plurality of concentric legs or tails {(8, 7), (8, 7″), (8″, 7″), (8′″, 7″′)} extruded from bottom surface of the tap body (2) and opened in concentric ports (3h, 3g) in the cartridge (3) respectively and mixed water/fluids flow out of a spout/outlet (14, 14′, 14 or 16″′) respectively when the tap handle (2) is turned in one direction and shuts off when turned in opposite direction in the first, the second, the eleventh and the twelfth embodiments respectively;
wherein the main body (D, E, F, G, H, M) comprising of a plurality of tap bodies {(2ay, 2ax), (2ay, 2ax), (2ay, 2ax), (2dx, 2dy), (2ex, 2ey), (2ex, 2ey, 2ez)}, a plurality of tap cartridges {(3ay, 3ax), (3ay, 3ax), (3ay, 3ax), (3dx , 3dy), (3ex, 3ey), (3ex, 3ey, 3ez)}, a plurality of tap handles {(1ay, 1ax), (1ay, 1ax), (1ay, 1ax), (1dx, 1dy), (1ex, 1ey), (1ex, 1ey, 1ez)} with a plurality of concentric legs or tails {(15a, 14a), (15a, 14a), (15a, 14a′), (13d, 12d), (13e, 12e), (15e, 18e, 25e)} extruded from the plurality of the tap bodies {(2ay, 2ax), (2ay, 2ax), (2ay, 2ax), (2dx, 2dy), (2ex, 2ey), (2ex, 2ey, 2ez)} and opened in a plurality of outlet {(5ay, 5ax), (5ay, 5ax), (5ay, 5ax), (5dx, 5dy), (5ex, 5ey), (5ex, 5ey, 5ez)} of a plurality of valve seat tubes {(4ayt, 4axt), (4ayt, 4axt), (4ayt, 4axt), (4dxt, 4dyt), (4ext, 4eyt), (4ext, 4eyt, 4ezt)} extruded inwardly from their respective tap bodies and mixed water/fluids flow out of a spout/outlet (12a, 12a, 12a′, 10d, 10e, 10e) respectively when the tap handles is turned in one direction and shuts off when turned in opposite direction in the third, the fourth, the fifth, the eighth, the ninth and the tenth embodiments respectively;
wherein the main body (A′, B′) comprising of a tap body (2b), a tap cartridge (3b), a tap handle (1b) with plurality of concentric legs or tails {(8″, 7″), (8″′, 7″′)} extruded from bottom surface of the tap body (2b) and opened in an outlet 5b and 8b respectively and mixed water/fluids flow out of an outlet (16b, 18b) respectively when the tap handle (2b) is turned in one direction and shuts off hot water/fluids when turned in opposite direction in the sixth and seventh embodiment respectively;
wherein the tap body (2, 2, 2, 2) extruded in the plurality of the concentric legs {(8,7), (8,7′), (8″, 7″), (8″′, 7′″)} from its bottom side supported by a plurality of connecting plates (6, 6, 6″, 6′″) in radial direction and the spout /outlet (14, 14′, 14, 16″′) extruded from side of the tap body (2, 2, 2, 2) respectively connecting the concentric legs to their respective spout for discharge of water/fluids in the first, the second, the eleventh and the twelfth embodiment respectively is a single piece/body and can be manufactured by means of casting/moulding using a single die;
wherein the tap body (2b) extruded in the plurality of the concentric legs {(6b, 7b), (6b, 7b′)} from its bottom side supported by a plurality of connecting plates (24b, 24b) in radial direction and a plurality of parallel spouts/outlets {(14b, 15b), (14b, 15b)} extruded from side of the tap bodies (2b, 2b, 2b, 2b) respectively connecting the concentric legs to their respective outlets for discharge of water/fluids in the sixth and the seventh embodiment respectively is a single piece/body and can be manufactured by means of casting/moulding using a single die;
wherein the plurality of the tap bodies {(2ax, 2ay), (2ax, 2ay), (2ax, 2ay), (2dy, 2dx)} extruded outwardly from their bottom sides in a plurality of concentric legs or tails {(14a, 15a), (14a, 15a), (14a′, 15a), (12d, 13d)} supported by at least a connecting plate {26a, 26a, 26a, 22d} and extruded inwardly in a valve seat tube {(4axt, 4ayt), (4axt, 4ayt), (4axt, 4ayt), (4dxt, 4dyt)} and extruded upwardly in a common header (13a, 13a′, 13a′,9d) having a mixing chamber (7a, 7a′, 7a′, 7d) respectively connecting the concentric legs to their respective header in the third, the fourth, the fifth and the eighth embodiment respectively is a single piece/body and can be manufactured by means of casting/moulding using a single die;
wherein a plurality of the tap bodies {(2ey, 2ex), (2ey, 2ex, 2ez)} extruded outwardly from their bottom sides in a plurality of parallel legs or tails {(24e, 13e), (24e, 13e, 29c)} connected to a plurality of male-threaded inlets {(18e, 15e), (18e, 15e, 25e) and supported by a plurality of connecting plates {(23e, 22e), 23e)} and extruded inwardly in a valve seat tube {(4ext, 4eyt), (4ext, 4eyt, 4ezt)} and extruded upwardly in a common header (9e, 9e) having a mixing chamber (7e, 7e) respectively connecting the parallel legs to their respective outlet (10e, 10e) for discharge of water/fluids in the ninth and the tenth embodiment is a single piece/body and can be manufactured by means of casting/moulding using a single die;
wherein the plurality of concentric legs are the outer leg (7, 7′, 14a, 14a′, 7b, 7b′, 12d, 12e, 12e′, 7″, 7″′) and the inner leg (8, 8, 15a, 15a, 15a, 6b, 6b, 13d, 13e, 13e′, 8″, 8″′) respectively;
wherein the male threaded outer leg (7′, 14a′, 7b′, 12d) having a plurality of inlet legs or tails near its bottom end wherein a male threaded first inlet or leg (12, 18a, 12b, 17d) and their respective inner legs (8, 15a, 6b, 13d) in axial direction are connected to the coupling (C) for hot water supply and the male threaded second inlet leg or tail (17, 24a, 23b, 19d) respectively is for connection to cold water supply line in the second, the fifth, the seventh, the eighth embodiment respectively;
wherein the male threaded outer leg (7, 14a, 14a, 7b) having male threaded first leg or tail at its bottom end the male threaded end at its bottom inner legs (8, 15a, 15a, 6b) connected to the taptee for hot water supply and cold water supply in the first, the third, the fourth and the sixth embodiment respectively;
wherein the inner leg (13e) having the male threaded inlet leg (15e) for hot water supply line and the inner leg (24e) having male threaded inlet leg (18e) for cold water supply line in the ninth embodiment;
wherein the inner leg (13e′) having the male threaded inlet leg (15e) for hot water supply line, the inner leg (24e) having male threaded inlet leg (18e) for cold water supply line and the inner leg (29e) having male threaded inlet leg (25e) for raw water supply line in the tenth embodiment;
wherein the inner leg (8″) bent at its bottom end extruded into a leg (9″) having threaded inner surface in the outer leg (7″) in radial direction for hot water supply line and the outer leg (7″) for connection to cold water supply line in the eleventh embodiment;
wherein the inner leg (8″′), bent at its bottom end, extruded into an opening in outer leg (7″′) in radial direction having outer threaded surface (9′″) for hot water supply line and the outer leg (7″′) extruded in radial direction into outlet (13″′) having outer threaded surface (12″′) for cold water supply line in the twelfth embodiment;
wherein the tap handle rotatably mounted about a longitudinal axis with respect to the tap body and operatively connected to their respective tap cartridge such that rotating the handle to a selected position connects plurality of inlets or legs to the mixer chamber for discharge of mixed water through the spout or outlet as disclosed in the various embodiments of the present invention the fluid mixer tap or body;
interlocking mechanism substantially as herein before described with reference to the third embodiment of the accompanying description which allows first cold water supply through the spout (12a) and then mixed water;

2. The fluid mixer tap or valve as claimed in claim 1 wherein the taptee (T) is having a tubular female threaded socket end (1t) at one end of a body (10t) having a valve seat (9t) and at other end is male threaded first leg or inlet (2t) in axial direction for hot water supply and second leg with outer threaded surface (4t) opening in radial direction from the body (10t) between the valve seat (9t) and the socket (1t) for cold water supply in a single body.

3. The fluid mixer tap or valve as claimed in claim 1 wherein the toupling (C) is having a tubular female threaded socket end (1c) at one end of a body (6c) having a valve seat (4c) and at other end is male threaded leg or inlet (2c) in axial direction for hot water supply in a single body.

4. The fluid mixer tap or valve as claimed in claim 1 wherein the tap cartridge (3) is double ceramic discs tap cartridge with bottom ceramic disc (K2) having a plurality of concentric inner holes (3h) and outer holes (3g) fitted inside a body (3a) touching to bottom surface of a moving upper ceramic disc (K1) connected to the bottom part of the tap spindle (3f) which is connected operatively to the tap handle (1).

5. The fluid mixer tap or valve as claimed in claims 1 and 4 wherein the main body (A) comprising:
the plurality of the concentric legs or tails (8, 7), extruded from bottom of the tap body (2) and the spout (14) extruded from its' side, connected by a plurality of connecting plates (6) in radial direction and extruded from top and connected to a plurality of concentric valve seats (4a, 4b) respectively allowing discharge of mixed water from hot and cold water supply through the concentric legs (8, 7) respectively in a single body;
wherein the concentric legs or tails (8, 7) connected to the concentric ports (3h, 3g) in the cartridge (3) such that discharge of fluid or water from all of them, finally entered into a common header for discharge of fluid in a mixer chamber (20) and then to the spout (14);
the tap handle (1) rotatably mounted about a longitudinal axis with respect to the tap body (2) and operatively connected to the tap cartridge or valve assembly (3) such that rotating the handle to a selected position connects concentric inner (3h) and outer (3g) port to the mixing chamber (20) in the tap body (2) and controls proportions of hot and cold water supplied from the mixing chamber (20) from the respective hot and cold water supply lines for discharge through the spout (14).

6. The fluid mixer tap or valve as claimed in claims 1 and 5 wherein the inner leg (8) is having male-threaded end (9) near its bottom end for tightening the nut (N2) and a stopper groove for the disc (Z1) and the outer leg (7) is having threaded outer surface first leg or tail (12).

7. The fluid mixer tap or valve as claimed in claims 1, 5, 6 wherein the back nut (N1) is screwed in the outer leg (7) for tightening the main body (A) to base of kitchen sinks, washbasins or bath tubs.

8. The fluid mixer tap or valve as claimed in claims 1, 5 to 7 wherein the tap body (2), the concentric legs (8, 7), the concentric valve seats (4a, 4b) and the spout (14) is made by means in a single piece/body and the male threaded end (9) is inserted into the disc (Z1) and the washer (W2) and then it is inserted into the valve seat (9t) and in parallel the female socket end (1t) of the taptee (T) is screwed in the first leg (12) and finally the nut (N2) is screwed in the bottom end (9) such that no water leaks from inner leg (8) to the outer leg (7) and vice versa;
wherein cold water supply entered the second leg (4t) and hot water supply entered the first leg (2t) and when the tap handle (1) rotates in one direction, water or fluids mixes in the mixing chamber (20) and then mixed water discharges through the spout (14) through the outlet (15) and when turned in opposite direction mixed water shuts off.

9. The fluid mixer tap or valve as claimed in claims 1, 3 to 6 wherein the outer leg (7) is the outer leg (7′) having plurality of inlet legs (12, 17), the first leg (12) in axial direction and the second leg (17) in radial direction.

10. The fluid mixer tap or valve as claimed in claims 1, 3 to 6 and 9 wherein the tap body (2), the concentric legs (8, 7′), the concentric valve seats (4a, 4b) and the spout (14′) is made by means in a single piece/body and the male threaded end (9) of the inner leg (8) is inserted in to the hollow disc (Z1) and the washer (W2) and then it is inserted into the valve seat (4c) and in parallel the female socket end (1c) of the toupling (C) is screwed in the first leg (12) of the outer leg (7′) and finally the nut (N2) is screwed in the bottom end (9) and tighten in such a way that no water leaks from inner leg (8) to the outer leg (7′) and vice versa and the second leg (17) is for cold water supply.

11. The fluid mixer tap or valve as claimed in claims 1, 4 and 5 wherein the inner leg (8) is the inner leg (8″) bent at its bottom end in radial direction, extruded in the outer leg (7″) having inner threaded surface (9″) for connection to hot water supply line and the outer leg (7″) having male threaded first leg (12″) for cold water supply line.

12. The fluid mixer tap or valve as claimed in claims 1, 4 and 5 wherein the inner leg (8) is the inner leg (8′″) bent at its bottom end in radial direction, extruded in the outer leg (7′″) having male threaded leg (9″) for connection to hot water supply line and the outer leg (7″) having male threaded first leg (12″′) for cold water supply line.

13. The fluid mixer tap or valve as claimed in claim 1, 3 wherein the main body (D) comprising:
the plurality of the tap bodies (2ay, 2ax) and the plurality of concentric legs or tails (15a, 14a), the inner leg (15a) and the outer leg (14a), extruded from bottom surface of the tap bodies (2ay, 2ax) connected to each other and their top ends extruded inside pluralities of the tap bodies (2ay, 2ax) connected to pluralities of valve seat tubes (4ayt, 4axt) respectively and a header (13a) extruded from top surface of the tap bodies (2ay, 2ax) and a partition wall between their respective outlet in a single body/piece in third embodiment;
wherein the plurality of concentric legs or tails (15a, 14a) connected to individual tap bodies (2ay) and (2ax) and to individual tap cartridges (3ay) and (3ax) respectively such that discharge of fluid or water from all concentric legs (15, 14a) finally entered into a common header (13a) for discharge of fluid in a mixer chamber (20) and then to the spout (12a) connected to the header 13a;
wherein the inner leg (15a) is having male threaded leg (17a) near its bottom end for tightening the nut (N2) and a stopper groove for the disc (Z1) and the outer leg (14a) having threaded outer surface and the male-threaded first leg (18a);
the tap handle (1ay) rotatably mounted about a longitudinal axis with respect to the tap body (2ay) and operatively connected to the tap cartridge or valve assembly (3ay) such that rotating the handle to a selected position connects an outlet (5) port to the mixing chamber (7a) and controls proportion of hot water discharge from the mixing chamber (7a) from the respective hot water supply lines for discharge through the spout (12a);
the tap handle (lax) rotatably mounted about a longitudinal axis with respect to the tap body (2ax) and operatively connected to the tap cartridge or valve assembly (3ax) such that rotating the handle to a selected position connects an outlet (5ax) port to the mixing chamber (7a) and controls proportion of cold water discharge from the mixing chamber (7a) from the respective cold water supply lines for discharge through the spout (12a);

14. The fluid mixer tap or valve as claimed in claims 1 and 13 wherein the back nut (N1) is screwed in the outer leg (14a) for tightening the main body (D) to base of kitchen sinks, washbasins or bath tubs.

15. The fluid mixer tap or valve as claimed in claims 1, 2, 13 and 14 wherein the pluralities of tap bodies (2ay, 2ax), the concentric legs (15a, 14a), pluralities of individual valve seat tubes (4ayt, 4axt) and the header (13a) is made by means in a single piece/body and the bottom end (17a) of the inner leg (15a) is inserted in to the hollow disc (Z1) and the washer (W2) and then it is inserted into the valve seat (9t) and in parallel the female socket end (1t) of the taptee (T) is screwed in the first leg (18a) of the outer leg (14a) and finally the nut (N2) is screwed in the bottom end (17a) and tighten in such a way that no water leaks from the inner leg (15a) to the outer leg (14a) and vice versa;.
wherein hot water supply entered the second leg (4t) and cold water supply entered the first leg (2t) and when the individual tap handles (1ay) and (1ax) rotates in one direction, water or fluids mixes in the mixing chamber (7a) and then mixed water discharges through the spout (12a) and when turned in opposite direction mixed water shuts off.

16. The fluid mixer tap or valve as claimed in claims 1 and 13 wherein the outer leg (14a) is the outer leg (14a′) having plurality of inlet legs (18a, 24a), the first leg (18a) in axial direction and the second leg (24a) in radial direction.

17. The fluid mixer tap or valve as claimed in claims 1, 3 , 13 and 16 wherein the pluralities of tap bodies (1ay, 2ax), the concentric legs (15a, 14a′), the concentric valve seat tubes (4ayt, 4axt) and the header (13a′) is made by means in a single piece/body and the male threaded leg (17a) of the inner leg (15a) is inserted in to the hollow disc (Z1) and the washer (W2) and then it is inserted into the valve seat (4c) and in parallel the female socket end (1c) of the toupling (C) is screwed in the first leg (18a) of the outer leg (14a′) and finally the nut (N2) is screwed in the leg (17a) and tighten in such a way that no water leaks from the inner leg (15a) to the outer leg (14a′) and vice versa and the second leg (24a) is for water supply.

18. The fluid mixer tap or valve as claimed in claims 1, 13 to 15 wherein the main body (D) having hot and cold water interlocking mechanism in the header (13a) rotating a header disc (8a) by flow of cold water by means of first rotating the tap handle (1ay) and then allowing hot water to enter the mixing chamber (7a) by means of rotating the tap handle (1ax) through an opening (L1d) in a header disc seat body (L1) fitted in the header (13a) and obstruct the flow of hot water discharge in the mixing chamber (7a) if tried first to rotate the tap handle (1ax) for hot water.

19. The fluid mixer tap or valve as claimed in claims 1 and 4 wherein the main body (A′) comprising:
the plurality of concentric legs or tails (6b, 7b), extruded from bottom of the tap body (2b) and a plurality of parallel spouts (14b, 15b) inside the spout (13b) extruded from its' side, connected by a plurality of connecting plates (24b) in radial direction and the inner leg (6b) extruded from top and converge in a valve seat (4b) allowing discharge of hot water supply through the spout (14b), the outer leg (7b) is connected to the spout (15b) allowing discharge of cold water supply and mixed water discharge through a mixing chamber (16b) of the spout (13b) in a single body;
wherein the inner leg or tail (6b) connected to the tap cartridge (3b) and the outer leg or tail (7b) connected to the spout (15b) such that discharge of fluid or water from all of them, finally entered into a common header for discharge of fluid in a mixer chamber (16b) after the spouts (14b) and (15b);
the tap handle (1b) rotatably mounted about a longitudinal axis with respect to the tap body (2b) and operatively connected to the tap cartridge or valve assembly (3b) such that rotating the handle to a selected position connects an outlet (5b) to the mixing chamber (16b) in the spout (13b) and controls proportions of hot water supplied from the mixing chamber (13b) from the hot water supply line and proportion of cold water supply line is done by external fitting for discharge through the spout (13b).

20. The fluid mixer tap or valve as claimed in claims 1 and 19 wherein the inner leg (6b) is having male-threaded end (10b) near its bottom end for tightening the nut (N2) and a stopper groove for the disc (Z1) and the outer leg (7b) is having threaded outer surface first leg or tail (12b).

21. The fluid mixer tap or valve as claimed in claims 1, 19, 20 wherein the back nut (N1) is screwed in the outer leg (7) for tightening the main body (A′) to base of kitchen sinks, washbasins or bath tubs.

22. The fluid mixer tap or valve as claimed in claims 1, 19, 20 wherein the tap body (2b), the concentric legs (6b, 7b), the valve seat (4b) and the spout (13b) is made by means in a single piece/body and the male threaded end (10b) is inserted into the disc (Z1) and the washer (W2) and then it is inserted into the valve seat (9t) and in parallel the female socket end (1t) of the taptee (T) is screwed in the first leg (12b) and finally the nut (N2) is screwed in the bottom end (10b) such that no water leaks from inner leg (6b) to the outer leg (7b) and vice versa;
wherein cold water supply entered the second leg (4t) and hot water supply entered the first leg (2t) and when the tap handle (1b) rotates in one direction and cold water supply is on, water or fluids mixes in the mixing chamber (16b) and then mixed water discharges through the outlet (16b) in the spout (13b) and when turned in opposite direction hot water shuts off.

23. The fluid mixer tap or valve as claimed in claims 1, 19, 20 wherein the outer leg (7) is the outer leg (7b′) having plurality of inlet legs (12b, 23b), the first leg (12b) in axial direction and the second leg (23b) in radial direction.

24. The fluid mixer tap or valve as claimed in claims 1, 19, 20 and 23 wherein the tap body (2b), the concentric legs (6b, 7b′), the valve seat (4b) and the spout (13b′) is made by means in a single piece/body and the male threaded end (10b) of the inner leg (6b) is inserted in to the hollow disc (Z1) and the washer (W2) and then it is inserted into the valve seat (4c) and in parallel the female socket end (1c) of the toupling (C) is screwed in the first leg (12) of the outer leg (7b′) and finally the nut (N2) is screwed in the bottom end (10b) and tighten in such a way that no water leaks from inner leg (6b) to the outer leg (7b′) and vice versa and the second leg (23b) is for cold water supply.

25. The fluid mixer tap or valve as claimed in claims 1, 3, 16, 17 wherein the main body (G) comprising:
the plurality of the tap bodies (2dx, 2dy) and the plurality of concentric legs or tails (13d, 12d), the inner leg (13d) and the outer leg (12d), extruded from bottom surface of the tap bodies (2dx, 2dy) connected to each other and their top ends extruded inside pluralities of the tap bodies (2dx, 2dy) connected to pluralities of valve seat tubes (4dxt, 4dyt) respectively and a header (9d) extruded from the tap bodies (2dx, 2dy) connected to the male threaded outer leg (10d) in a single body/piece in the eighth embodiment;

26. The fluid mixer tap or valve as claimed in claim 1 wherein the main body (M) comprising:
the plurality of the tap bodies (2ex, 2ey, 2ez) and the pluralities of parallel inlet legs or tails (13e′, 24e, 29e) extruded from bottom surface of the tap bodies (2ex, 2ey, 2ez) respectively and connected to each other and their top ends extruded inside pluralities of tap bodies (2ex, 2ey, 2ez) connecting to pluralities of valve seat tubes (4ext, 4eyt, 4ezt) respectively and a common header (9e) extruded from side surface of the tap bodies (2ex, 2ey, 2ez) having pluralities of parallel inlets (15e, 18e, 25e) respectively and one outlet (10e) in a single body/piece (M);
wherein the plurality of parallel legs or tails (13e′, 24e, 29e) connected to their respective individual tap body (2ex), (2ey) and (2ez) and to the individual tap cartridge (3ex), (3ey) and (3ez) respectively such that discharge of fluid or water from all the parallel inlet legs (13e′, 24e, 29e) finally discharged into a common header (9e) for discharge of water/fluid in a mixer chamber (7e) and then to the outlet male threaded end (10e) of the header (9e);
wherein the plurality of inlet legs (15e, 18e, 25e) are having outer male threaded surface for connection to hot, cold and raw water supply lines respectively.
the individual tap handles (1ex), (1ey), and (1ez) rotatably mounted about a longitudinal axis with respect to their respective tap bodies (2ex), (2ey) and (2ez) and operatively connected to their individual tap cartridges or valve assemblies (3ex), (3ey) and (3ez) such that rotating the handles (1ex), (1ey) and (1ez) to a selected position connects individual outlets port (5ex), (5ey) and (5ez) to the mixing chamber (7e) and controls proportion of hot, cold and raw water supplied from the mixing chamber (7e) from the respective cold, hot and raw water supply lines for discharge through the outlet (10e).

27. The fluid mixer tap or valve in further embodiments where in the inner leg (6b, 8, 13d or 15a) at its lower end is lower tubular body or portion (8z) comprising of a tube (8za) having hose barb (8ze) at its bottom connected to a hose barb (8zf) of a lower body /portion (8zb) by means of a flexible hose pipe (8zc), where in the nut (N2) is screwed in the male threaded end of the lower portion (8zb), substantially as herein before described with reference to FIG. 21 of the accompanying drawings.
